(19) United States
(12) Patent Application Publication
(10) Pub. No.: US 2026/0307593 A1
(43) Pub. Date: Oct. 8, 2026

(54) BICYCLE CARRIER WITH RATCHETING MECHANISM FOR BICYCLE SECUREMENT ARM

(71) Applicant: Thule Sweden AB, Hillerstorp (SE)

(72) Inventors: Hannes FALK, Ulricehamn (SE); Fredrik LARSSON, Vaggeryd (SE); Tam LE, Värnamo (SE); Vanesa AHMETSPAHIC, Värnamo (SE); Wilbert HAK, Skillingaryd (SE)

(21) Appl. No.: 19/633,323

(22) Filed: Mar. 30, 2026

Related U.S. Application Data
(60) Provisional application No. 63/947,839, filed on Dec. 23, 2025.
(60) Provisional application No. 63/783,620, filed on Apr. 4, 2025.

(51) Int. Cl. B60R 9/10; B60R 9/06

(52) U.S. Cl. CPC B60R 9/10; B60R 9/06

(57) ABSTRACT

A bicycle carrier includes a wheel tray, a wheel securement arm, and a ratcheting mechanism. The wheel tray is configured to support a wheel of a bicycle. The wheel tray includes a hub disposed a distal end of the wheel tray. The wheel securement arm couples to the distal end of the wheel tray. The wheel securement arm is configured to rotate relative to the wheel tray between a first position and a second position. The ratcheting mechanism couples to the wheel tray and the wheel securement arm and be at least partially disposed in the hub. The ratcheting mechanism is configured to control rotation of the wheel securement arm relative to the wheel tray.

### CROSS REFERENCE TO RELATED APPLICATIONS

This application claims priority to U.S. Provisional Application No. 63/783,620, filed Apr. 4, 2025, and U.S. Provisional Application No. 63/947,839, filed Dec. 23, 2025, which are hereby incorporated herein in their entirety by reference.

### BACKGROUND

### Field

The present disclosure relates to load carriers. More specifically, embodiments of the present disclosure relate to vehicle mounted load carriers, for example, bicycle carriers.

### Background

Devices for carrying equipment on a vehicle can be used to transport the equipment from one place to another. In some examples, the load carrier can be secured to the vehicle safely and conveniently via a hitch, typically attached to the rear of the vehicle. Various mechanisms can be used to secure a load (e.g., a bicycle) to the load carrier, for example, straps and securement arms. However, in certain cases these devices can be cumbersome, unstable, difficult to use, or fail to securely fasten or balance the bicycle to the load carrier in a sufficient manner.

### BRIEF SUMMARY

Accordingly, there is a need to provide a load carrier that securely holds a load on the carrier and improves user operation of loading and unloading loads to the carrier.

In some embodiments, a bicycle carrier can include a wheel tray, a hub, a wheel securement arm, and a ratcheting mechanism. In some embodiments, the wheel tray can be configured to support a wheel of a bicycle. In some embodiments, the hub can be disposed on the wheel tray. In some embodiments, the wheel securement arm couples to the wheel tray and is configured to rotate relative to the wheel tray from a first position to a second position. In some embodiments, the ratcheting mechanism couples to the wheel tray and the wheel securement arm and is at least partially disposed in the hub. In some embodiments, the ratcheting mechanism is configured to control rotation of the wheel securement arm relative to the wheel tray.

In some embodiments, the ratcheting mechanism includes an actuator configured to move the ratcheting mechanism from an engaged position to a disengaged position. In some embodiments, the wheel securement arm is configured to move in the first direction when the ratcheting mechanism is in the disengaged position, and the wheel securement arm is blocked from moving in the first direction when the ratcheting mechanism is in the engaged position.

In some embodiments, the wheel securement arm includes an arm base. In some embodiments, the ratcheting mechanism is at least partially disposed in a cavity formed in the arm base. In some embodiments, the ratcheting mechanism includes an actuator configured to move the ratcheting mechanism from an engaged position to a disengaged position. In some embodiments, the actuator is disposed on a first side of the arm base of the wheel securement arm. In some embodiments, the cavity is formed in a second side of the arm base opposite the first side.

In some embodiments, the wheel securement arm includes an arm base. In some embodiments, the arm base includes a rim having an indicator on a first side of the arm base. In some embodiments, the ratcheting mechanism includes an actuator configured to move the ratcheting mechanism from an engaged position to a disengaged position. In some embodiments, the indicator is visible when the actuator moves the ratcheting mechanism into the disengaged position. In some embodiments, the indicator is hidden by the actuator when the ratcheting mechanism is in the engaged position.

In some embodiments, the ratcheting mechanism includes a first toothed ring movably coupled to the hub. In some embodiments, the first toothed ring includes a plurality of teeth. In some embodiments, the plurality of teeth extend axially away from the first toothed ring and engage with a second plurality of teeth of the ratcheting mechanism. In some embodiments, the first toothed ring is configured to translate within the hub. In some embodiments, the first toothed ring is biased outwardly from the hub. In some embodiments, the hub includes a plurality of splines configured to prevent rotation of the first toothed ring. In some embodiments, the hub includes at least one protrusion extending away from the hub and configured to engage with at least one aperture formed through the first toothed ring to prevent rotation of the first toothed ring relative to the hub.

In some embodiments, the ratcheting mechanism includes a second toothed ring movably coupled to the wheel securement arm and configured to movably engage with the first toothed ring. In some embodiments, the ratcheting mechanism includes a spacer disposed between the first toothed ring and the second toothed ring and configured to limited movement of the first toothed ring relative to the hub.

In some embodiments, the ratcheting mechanism includes an actuator coupled to the second toothed ring. In some embodiments, the ratcheting mechanism is configured to move the second toothed ring such that the ratcheting mechanism moves from an engaged position to a disengaged position. In some embodiments, the second toothed ring is spaced apart from the first toothed ring in the disengaged position. In some embodiments, the ratcheting mechanism includes a second toothed ring fixedly coupled to the wheel securement arm and configured to engage with the first toothed ring.

In some embodiments, the actuator includes an actuator button and a push member. In some embodiments, the actuator button is rotatably coupled to the wheel securement arm. In some embodiments, the push member is configured to translate relative to the actuator button. In some embodiments, the ratcheting mechanism includes a first toothed ring and a second toothed ring. In some embodiments, when the actuator is rotated, the push member translates and moves the first toothed ring away from the second toothed ring to disengage the ratcheting mechanism.

In some embodiments, the first toothed ring includes a plurality of apertures configured to receive a plurality of protrusions extending away from the hub. In some embodiments, the second toothed ring includes a plurality of apertures configured to receive a plurality of protrusions extending away from an arm base of the wheel securement arm. In some embodiments, the first toothed ring is moveably coupled to the hub and the second toothed ring is fixedly coupled to the hub.

In some embodiments, the push member includes an actuating surface, a first notch formed in the actuating surface, and a second notch formed in the actuating surface. In some embodiments, the first notch has an engaged depth relative to the actuating surface and the second notch has a disengaged depth relative to the actuating surface less than the engaged depth. In some embodiments, the actuator button includes a protrusion configured to engage the first and second notches of the push member when the actuator button is rotated.

In some embodiments, when the protrusion engages the first notch, the ratcheting mechanism is in the engaged position. In some embodiments, when the protrusion engages the second notch, the ratcheting mechanism is in the disengaged position. In some embodiments, the first notch is circumferentially spaced apart from the second notch. In some embodiments, the first notch extends across the diameter of the actuating surface and intersects the second notch.

In some embodiments, the actuator automatically moves the ratcheting mechanism into the engaged position when the wheel securement arm moves into the second position from the first position.

In some embodiments, a bicycle carrier includes a wheel tray, a wheel securement arm, and an axle. In some embodiments, the wheel tray is configured to support a wheel of a bicycle. In some embodiments, the wheel securement arm couples to the wheel tray and is configured to rotate relative to the wheel tray from a first position to a second position. In some embodiments, the axle couples to a proximal end of the wheel securement arm and extends through the wheel tray. In some embodiments, the axle is configured to rotate with the wheel securement arm. In some embodiments, the axle includes a polygonal cross-sectional shape.

In some embodiments, the bicycle carrier includes a biasing mechanism coupled to the axle and configured to bias the wheel securement arm from the first position to the second position. In some embodiments, the biasing mechanism includes a first body fixed with the axle, a second body fixed with the wheel tray, and a spring that biases at least one of the first body and the second body toward the other. In some embodiments, the first body includes a first sloped end wall and the second body includes a second sloped end wall that faces the first sloped end wall. In some embodiments, when the first sloped end wall is biased toward the second sloped end wall, the first body rotates relative to the second body to rotate the wheel securement arm relative to the wheel tray.

In some embodiments, a bicycle carrier is configured to secure a bicycle and includes a wheel tray and a wheel securement arm. In some embodiments, the wheel tray is configured to support a wheel of the bicycle. In some embodiments, the wheel securement arm couples to the wheel tray at a first attachment point. In some embodiments, the wheel securement arm includes a fixed end, a distal end, and a pair of upright arms. In some embodiments, the fixed end rotatably couples to the wheel tray at the first attachment point. In some embodiments, the distal end includes a bridge. In some embodiments, the bridge couples the pair of upright arms together at the distal end. In some embodiments, the pair of upright arms extend from the fixed end to the distal end. In some embodiments, the pair of upright arms are spaced apart by a first width at the distal end and a second width greater than the first width at the fixed end.

In some embodiments, the pair of upright arms extend linearly from the fixed end to the distal end without any bends. In some embodiments, a first arm of the pair of upright arms extends at a first angle relative to a second arm of the pair of upright arms. In some embodiments, the wheel securement arm includes a brace coupled to the pair of upright arms at the fixed end

In some embodiments, the bicycle carrier includes an axle coupled between the pair of upright arms at the fixed end. In some embodiments, a cross-sectional shape of the axle is a polygonal shape. In some embodiments, the cross-sectional shape is hexagonal. In some embodiments, a plurality of slots are formed in the axle to increase a torsional stiffness of the axle. In some embodiments, the axle is configured to rotate with the wheel securement arm relative to the wheel tray.

In some embodiments, a bicycle carrier is configured to secure a bicycle. In some embodiments, the bicycle carrier includes a wheel tray, a wheel securement arm, and a wheel chock. In some embodiments, the wheel tray is configured to support a wheel of the bicycle. In some embodiments, the wheel securement arm couples to the wheel tray. In some embodiments, the wheel securement arm includes a first arm, a second arm extending non-parallel to the first arm, a first tapered insert coupled to the first arm, and a second tapered insert coupled to the second arm. In some embodiments, the wheel chock movably couples to the wheel securement arm. In some embodiments, the wheel chock is configured to slide along the first tapered insert and second tapered insert.

In some embodiments, a first inward facing surface of the first tapered insert and a second inward facing surface of the second tapered insert are approximately parallel. In some embodiments, the first inward facing surface and the second inward facing surface each include a plurality of protrusions configured to engage the wheel chock to temporarily hold the wheel chock in a plurality of positions relative to the wheel securement arm.

In some embodiments, the first arm, the second arm, the first tapered insert, and the second tapered insert each include a plurality of apertures. In some embodiments, the wheel chock includes a securement bar configured to extend through a first set of the plurality of apertures to secure the wheel chock in a first position.

In some embodiments, the wheel chock extends around a portion of a perimeter of the first arm. In some embodiments, the wheel chock includes a securement bar. In some embodiments, a clamp of the securement bar extends around a portion of the perimeter of the first arm.

In some embodiments, a bicycle carrier is configured to secure a bicycle. In some embodiments, the bicycle carrier includes a wheel tray, a wheel securement arm, and a wheel chock. In some embodiments, the wheel tray is configured to support a wheel of the bicycle. In some embodiments, the wheel securement arm couples to the wheel tray. In some embodiments, the wheel securement arm includes a first arm and a second arm. In some embodiments, the wheel chock movably couples to the wheel securement arm. In some embodiments, the wheel chock is configured to slide along the first arm and second arm. In some embodiments, the wheel chock includes a movable wheel receiving body configured to receive the wheel of the bicycle and move relative to the wheel securement arm to secure the wheel to the bicycle carrier.

In some embodiments, the wheel receiving body rotates relative to the wheel securement arm. In some embodiments, the wheel chock includes a torsional spring coupled between the wheel receiving body and the wheel securement arm and configured to rotate the wheel receiving body. In some embodiments, the wheel chock includes a fixed arm and a biasing member coupled to the fixed arm. In some embodiments, the biasing member is configured to bias the wheel receiving body relative to the fixed arm. In some embodiments, the biasing member is one of a spring, an airbag, or a cushion.

Implementations of any of the techniques described above may include a system, a method, a process, a device, and/or an apparatus. The details of one or more implementations are set forth in the accompanying drawings and the description below. Other features will be apparent from the description and drawings, and from the claims.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate the embodiments and, together with the description, further serve to explain the principles and to enable a person skilled in the relevant art(s) to make and use the embodiments. Objects and advantages of illustrative, non-limiting embodiments will become more apparent by describing them in detail with reference to the attached drawings.

FIG. 1 illustrates a perspective view of a bicycle carrier, according to an embodiment.

FIG. 2A illustrates a perspective view of a bicycle carrier with a wheel securement arm in a closed position, according to an embodiment.

FIG. 2B illustrates a perspective view of a bicycle carrier with a wheel securement arm in a loading position, according to an embodiment.

FIG. 3A illustrates an exploded view of a wheel tray, a wheel securement arm, and a ratcheting mechanism for a bicycle carrier, according to an embodiment.

FIG. 3B illustrates an exploded view of a wheel tray, a wheel securement arm, and a ratcheting mechanism for a bicycle carrier, according to an embodiment.

FIG. 4 illustrates a perspective view of a ratcheting mechanism, according to an embodiment.

FIG. 5A illustrates a cross-sectional view of a ratcheting mechanism in an engaged position, according to an embodiment.

FIG. 5B illustrates a cross-sectional view of a ratcheting mechanism in a disengaged position, according to an embodiment.

FIG. 6A illustrates an actuator for a ratcheting mechanism in a disengaged position, according to an embodiment.

FIG. 6B illustrates an actuator for a ratcheting mechanism in an engaged position, according to an embodiment.

FIG. 7A illustrates a cutaway perspective view of a ratcheting mechanism for a bicycle carrier, according to an embodiment.

FIG. 7B illustrates a cross-sectional perspective view of a ratcheting mechanism for a bicycle carrier, according to an embodiment.

FIG. 8 illustrates a perspective view of a ratcheting mechanism for a bicycle carrier, according to an embodiment.

FIG. 9 illustrates a front view of a lower portion of a wheel securement arm, according to an embodiment.

FIG. 10 illustrates a cross-sectional view of a lower portion of a wheel securement arm, according to an embodiment.

FIG. 11 illustrates a cutaway perspective view of an axle for a wheel securement arm, according to an embodiment.

FIG. 12 Illustrates a perspective view of a wheel securement arm including a brace, according to an embodiment.

FIG. 13A illustrates a cutaway perspective view of a biasing mechanism for a wheel securement arm in a first position, according to an embodiment.

FIG. 13B illustrates a cutaway perspective view of a biasing mechanism for a wheel securement arm in a second position, according to an embodiment.

FIG. 14 illustrates a front view of a wheel securement arm, according to an embodiment.

FIG. 15 illustrates a cross-sectional view of a wheel securement arm, according to an embodiment.

FIG. 16A illustrates a securement bar inserted through a wheel chock, according to an embodiment.

FIG. 16B illustrates a securement bar partially inserted in a wheel chock, according to an embodiment.

FIG. 17 illustrates a cross-sectional view of a securement bar extending through a wheel chock, according to an embodiment.

FIG. 18 illustrates a perspective view of a wheel chock, according to an embodiment.

FIG. 19 illustrates a cross-sectional view of a wheel chock, according to an embodiment.

FIG. 20 illustrates an exploded perspective view of a wheel chock, according to an embodiment.

FIG. 21 illustrates a perspective view of a bicycle carrier with a wheel securement arm in a loading position, according to an embodiment.

FIG. 22A illustrates an exploded view of a ratcheting mechanism for a bicycle carrier wheel securement arm, according to an embodiment.

FIG. 22B illustrates an exploded view of a ratcheting mechanism for a bicycle carrier wheel securement arm, according to an embodiment.

FIG. 23 illustrates an actuator button for a ratcheting mechanism, according to an embodiment.

FIG. 24A illustrates a perspective view of a ratcheting mechanism in an engaged position, according to an embodiment.

FIG. 24B illustrates a perspective view of a ratcheting mechanism in a disengaged position, according to an embodiment.

FIG. 25A illustrates a cross-sectional view of a ratcheting mechanism in an engaged position, according to an embodiment.

FIG. 25B illustrates a cross-sectional view of a ratcheting mechanism in a disengaged position, according to an embodiment.

FIG. 26 illustrates a cutaway perspective view of an axle for a wheel securement arm, according to an embodiment.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Embodiments of the present disclosure are described in detail with reference to embodiments thereof as illustrated in the accompanying drawings. References to “one embodiment,” “an embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Spatially relative terms, such as “beneath,” “below,” “lower,” “above,” “on,” “upper,” “opposite” and the like, may be used herein for ease of description to describe one element or feature’s relationship to another element(s) or feature(s) as illustrated in the figures. The spatially relative terms are intended to encompass different orientations of the device in use or in operation in addition to the orientation depicted in the figures. The apparatus may be otherwise oriented (e.g., rotated 90 degrees or at other orientations) and the spatially relative descriptors used herein may likewise be interpreted accordingly.

The term “about” or “substantially” as used herein indicates the value of a given quantity that can vary based on a particular technology. Based on the particular technology, the term “about” or “substantially” can indicate a value of a given quantity that varies within, for example, 1–15% of the value (e.g., ±1%, ±2%, ±5%, ±10%, or ±15% of the value).

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

Embodiment 1 of the description – A bicycle carrier includes a wheel tray configured to support a wheel of a bicycle; a hub disposed on the wheel tray; a wheel securement arm coupled to the wheel tray and configured to rotate relative to the wheel tray from a first position to a second position; and a ratcheting mechanism coupled to the wheel tray and the wheel securement arm and at least partially disposed in the hub, wherein the ratcheting mechanism is configured to control rotation of the wheel securement arm relative to the wheel tray.

Embodiment 2 of the description – The bicycle carrier of embodiment 1, wherein the ratcheting mechanism includes an actuator configured to move the ratcheting mechanism from an engaged position to a disengaged position.

Embodiment 3 of the description – The bicycle carrier of embodiment 2, wherein the wheel securement arm is configured to move in the first direction when the ratcheting mechanism is in the disengaged position, and the wheel securement arm is blocked from moving in the first direction when the ratcheting mechanism is in the engaged position.

Embodiment 4 of the description – The bicycle carrier of embodiment 1, wherein the wheel securement arm includes an arm base, and wherein the ratcheting mechanism is at least partially disposed in a cavity formed in the arm base.

Embodiment 5 of the description – The bicycle carrier of embodiment 4, wherein the ratcheting mechanism includes an actuator configured to move the ratcheting mechanism from an engaged position to a disengaged position, and wherein the actuator is disposed on a first side of the arm base of the wheel securement arm, and wherein the cavity is formed in a second side of the arm base opposite the first side.

Embodiment 6 of the description – The bicycle carrier of embodiment 1, wherein the wheel securement arm includes an arm base, the arm base includes a rim having an indicator on a first side of the arm base, wherein the ratcheting mechanism includes an actuator configured to move the ratcheting mechanism from an engaged position to a disengaged position, and wherein the indicator is visible when the actuator moves the ratcheting mechanism into the disengaged position, and wherein the indicator is hidden by the actuator when the ratcheting mechanism is in the engaged position.

Embodiment 7 of the description – The bicycle carrier of embodiment 1, wherein the ratcheting mechanism includes a first toothed ring movably coupled to the hub.

Embodiment 8 of the description – The bicycle carrier of embodiment 7, wherein the first toothed ring includes a plurality of teeth, and wherein the plurality of teeth extend axially away from the first toothed ring and engage with a second plurality of teeth of the ratcheting mechanism.

Embodiment 9 of the description – The bicycle carrier of embodiment 7, wherein the first toothed ring is configured to translate within the hub.

Embodiment 10 of the description – The bicycle carrier of embodiment 7, wherein the first toothed ring is biased outwardly from the hub.

Embodiment 11 of the description – The bicycle carrier of embodiment 7, wherein the hub includes a plurality of splines configured to prevent rotation of the first toothed ring.

Embodiment 12 of the description – The bicycle carrier of embodiment 7, wherein the hub includes at least one protrusion extending away from the hub and configured to engage with at least one aperture formed through the first toothed ring to prevent rotation of the first toothed ring relative to the hub.

Embodiment 13 of the description – The bicycle carrier of embodiment 7, wherein the ratcheting mechanism further includes a second toothed ring movably coupled to the wheel securement arm and configured to movably engage with the first toothed ring.

Embodiment 14 of the description – The bicycle carrier of embodiment 13, wherein the ratcheting mechanism includes a spacer disposed between the first toothed ring and the second toothed ring and configured to limited movement of the first toothed ring relative to the hub.

Embodiment 15 of the description – The bicycle carrier of embodiment 13, wherein the ratcheting mechanism includes an actuator coupled to the second toothed ring and configured to move the second toothed ring such that the ratcheting mechanism moves from an engaged position to a disengaged position.

Embodiment 16 of the description – The bicycle carrier of embodiment 15, wherein the second toothed ring is spaced apart from the first toothed ring in the disengaged position.

Embodiment 17 of the description – bicycle carrier of embodiment 7, wherein the ratcheting mechanism includes a second toothed ring fixedly coupled to the wheel securement arm and configured to engage with the first toothed ring.

Embodiment 18 of the description – The bicycle carrier of embodiment 2, wherein the actuator includes an actuator button and a push member, wherein the actuator button is rotatably coupled to the wheel securement arm, and wherein the push member is configured to translate relative to the actuator button.

Embodiment 19 of the description – The bicycle carrier of embodiment 18, wherein the ratcheting mechanism includes a first toothed ring and a second toothed ring, and wherein when the actuator is rotated, the push member translates and moves the first toothed ring away from the second toothed ring to disengage the ratcheting mechanism.

Embodiment 20 of the description – The bicycle carrier of embodiment 19, wherein the first toothed ring includes a plurality of apertures configured to receive a plurality of protrusions extending away from the hub, and the second toothed ring includes a plurality of apertures configured to receive a plurality of protrusions extending away from an arm base of the wheel securement arm.

Embodiment 21 of the description – The bicycle carrier of embodiment 20, wherein the first toothed ring is moveably coupled to the hub and the second toothed ring is fixedly coupled to the hub.

Embodiment 22 of the description – The bicycle carrier of embodiment 18, wherein the push member includes an actuating surface, a first notch formed in the actuating surface, and a second notch formed in the actuating surface, and wherein the first notch has an engaged depth relative to the actuating surface and the second notch has a disengaged depth relative to the actuating surface less than the engaged depth.

Embodiment 23 of the description – The bicycle carrier of embodiment 22, wherein the actuator button includes a protrusion configured to engage the first and second notches of the push member when the actuator button is rotated, wherein when the protrusion engages the first notch, the ratcheting mechanism is in the engaged position, and wherein when the protrusion engages the second notch, the ratcheting mechanism is in the disengaged position.

Embodiment 24 of the description – The bicycle carrier of embodiment 22, wherein the first notch is circumferentially spaced apart from the second notch.

Embodiment 25 of the description – The bicycle carrier of embodiment 22, wherein the first notch extends across the diameter of the actuating surface and intersects the second notch

Embodiment 26 of the description – The bicycle carrier of embodiment 2, wherein the actuator automatically moves the ratcheting mechanism into the engaged position when the wheel securement arm moves into the second position from the first position.

Embodiment 27 of the description – A bicycle carrier includes a wheel tray configured to support a wheel of a bicycle; a wheel securement arm coupled to the wheel tray and configured to rotate relative to the wheel tray from a first position to a second position; and an axle coupled to a proximal end of the wheel securement arm and extending through the wheel tray, wherein the axle is configured to rotate with the wheel securement arm.

Embodiment 28 of the description – The bicycle carrier of embodiment 27, wherein the axle includes a polygonal cross-sectional shape.

Embodiment 29 of the description – The bicycle carrier of embodiment 27, further includes a biasing mechanism coupled to the axle and configured to bias the wheel securement arm from the first position to the second position, wherein the biasing mechanism includes a first body fixed with the axle, a second body fixed with the wheel tray, and a spring that biases at least one of the first body and the second body toward the other.

Embodiment 30 of the description – The bicycle carrier of embodiment 29, wherein the first body includes a first sloped end wall and the second body includes a second sloped end wall that faces the first sloped end wall, and wherein when the first sloped end wall is biased toward the second sloped end wall, the first body rotates relative to the second body to rotate the wheel securement arm relative to the wheel tray.

Embodiment 31 of the description – A bicycle carrier configured to secure a bicycle, the bicycle carrier includes a wheel tray configured to support a wheel of the bicycle; and a wheel securement arm coupled to the wheel tray at a first attachment point, the wheel securement arm includes a fixed end rotatably coupled to the wheel tray at the first attachment point, a distal end that includes a bridge, wherein the bridge couples a pair of upright arms together at the distal end, and the pair of upright arms extending from the fixed end to the distal end, wherein the pair of upright arms are spaced apart by a first width at the distal end and a second width greater than the first width at the fixed end.

Embodiment 32 of the description – The bicycle carrier of embodiment 31, wherein the pair of upright arms extend linearly from the fixed end to the distal end without any bends.

Embodiment 33 of the description – The bicycle carrier of embodiment 31, further includes an axle coupled between the pair of upright arms at the fixed end.

Embodiment 34 of the description – The bicycle carrier of embodiment 33, wherein a cross-sectional shape of the axle is a polygonal shape.

Embodiment 35 of the description – The bicycle carrier of embodiment 34, wherein the cross-sectional shape is hexagonal.

Embodiment 36 of the description – The bicycle carrier of embodiment 33, wherein a plurality of slots are formed in the axle to increase a torsional stiffness of the axle.

Embodiment 37 of the description – The bicycle carrier of embodiment 33, wherein the axle is configured to rotate with the wheel securement arm relative to the wheel tray.

Embodiment 38 of the description – The bicycle carrier of embodiment 31, wherein a first arm of the pair of upright arms extends at a first angle relative to a second arm of the pair of upright arms.

Embodiment 39 of the description – The bicycle carrier of embodiment 31, wherein the wheel securement arm includes a brace coupled to the pair of upright arms at the fixed end.

Embodiment 40 of the description – A bicycle carrier configured to secure a bicycle, the bicycle carrier includes a wheel tray configured to support a wheel of the bicycle; a wheel securement arm coupled to the wheel tray, the wheel securement arm includes a first arm, a second arm extending non-parallel to the first arm, a first tapered insert coupled to the first arm, and a second tapered insert coupled to the second arm; and a wheel chock movably coupled to the wheel securement arm and configured to slide along the first tapered insert and second tapered insert.

Embodiment 41 of the description – The bicycle carrier of embodiment 40, wherein a first inward facing surface of the first tapered insert and a second inward facing surface of the second tapered insert are approximately parallel.

Embodiment 42 of the description – The bicycle carrier of embodiment 41, wherein the first inward facing surface and the second inward facing surface each include a plurality of protrusions configured to engage the wheel chock to temporarily hold the wheel chock in a plurality of positions relative to the wheel securement arm.

Embodiment 43 of the description – The bicycle carrier of embodiment 40 wherein the first arm, the second arm, the first tapered insert, and the second tapered insert each include a plurality of apertures.

Embodiment 44 of the description – The bicycle carrier of embodiment 43, wherein the wheel chock includes a securement bar configured to extend through a first set of the plurality of apertures to secure the wheel chock in a first position.

Embodiment 45 of the description – The bicycle carrier of embodiment 40, wherein the wheel chock extends around a portion of a perimeter of the first arm.

Embodiment 46 of the description – The bicycle carrier of embodiment 45, wherein the wheel chock includes a securement bar, and wherein a clamp of the securement bar extends around a portion of the perimeter of the first arm.

Embodiment 47 of the description – A bicycle carrier configured to secure a bicycle, the bicycle carrier includes a wheel tray configured to support a wheel of the bicycle; a wheel securement arm coupled to the wheel tray, the wheel securement arm includes a first arm and a second arm; and a wheel chock movably coupled to the wheel securement arm and configured to slide along the first arm and second arm, wherein the wheel chock includes a movable wheel receiving body configured to receive the wheel of the bicycle and move relative to the wheel securement arm to secure the wheel to the bicycle carrier.

Embodiment 48 of the description – The bicycle carrier of embodiment 47, wherein the wheel receiving body rotates relative to the wheel securement arm.

Embodiment 49 of the description – The bicycle carrier of embodiment 48, wherein the wheel chock further includes a torsional spring coupled between the wheel receiving body and the wheel securement arm and configured to rotate the wheel receiving body.

Embodiment 50 of the description – The bicycle carrier of embodiment 47, wherein the wheel chock further includes a fixed arm and a biasing member coupled to the fixed arm and configured to bias the wheel receiving body relative to the fixed arm.

Embodiment 51 of the description – The bicycle carrier of embodiment 50, wherein the biasing member is one of a spring, an airbag, or a cushion.

Embodiments of the load carriers disclosed herein can be used with, for example, but not limited to, a bicycle carrier. More specifically, the load carriers can include a vehicle mounted bicycle carrier, for example, a hitch-mounted bicycle carrier that can be attached to a hitch receiver of a vehicle. The load carriers can be configured to secure one, two, or more bicycles.

As discussed above, it is important to securely mount a load, such as a bicycle, onto a load carrier to reduce motion forces imparted on the bicycle that can result in instability and damage. Therefore, it is important to have a load carrier that is easy to use, for example, can be operated with one hand, and that has improved versatility to accommodate different shapes and sizes of bicycles and wheel diameters. Further, with increased electrification in bicycles, and associated weight increases, it is important to have a load carrier that can accommodate a wider range of weights and loads on the load carrier. To accommodate heavier loads, it is important for the wheel securement arms to be shaped and include features that increased torsional stiffness to support the increased weight.

Embodiments of load carrier apparatuses discussed below can provide versatility for securing loads of different shapes and sizes and improved ease of use for a user loading and unloading a bicycle on to the load carrier.

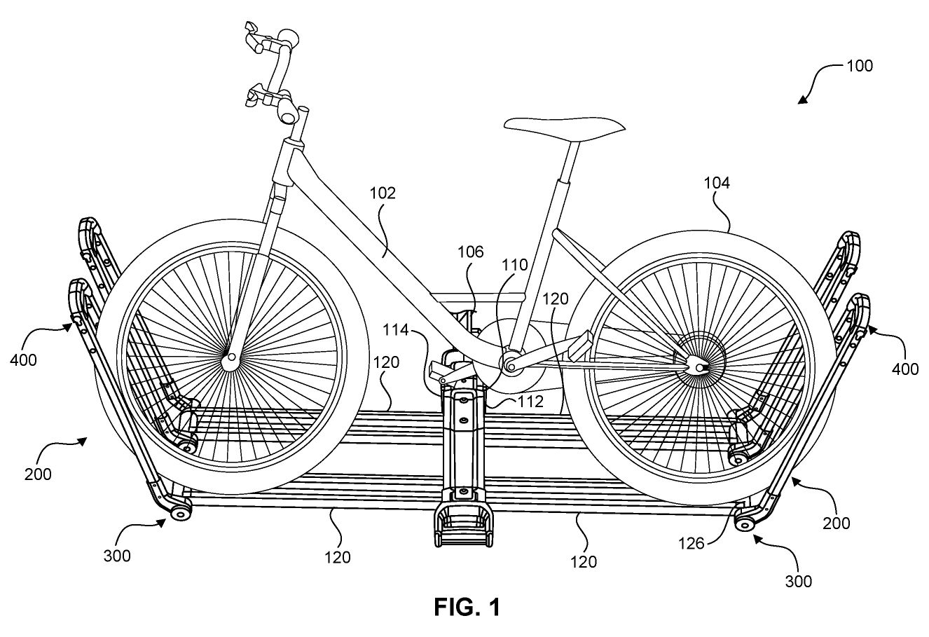

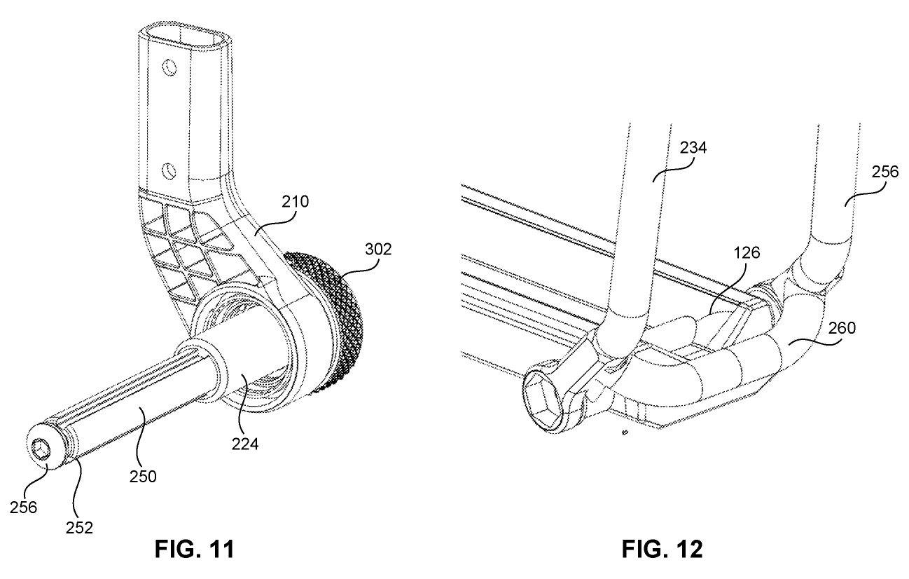

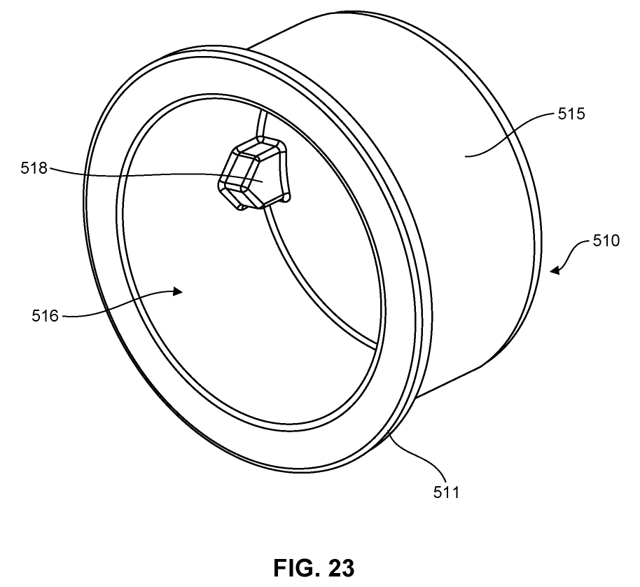

FIGS. 1–26 illustrate a load carrier 100, according to embodiments. Load carrier 100 can be configured to secure a load, for example, a bicycle 102, using a wheel securement arm 200 coupled to a wheel tray 120. In some embodiments, wheel securement arm 200 can be configured to rotate relative to wheel tray 120 from a first position 10, such as a closed configuration, to a second position 20 such as a loading position to secure a wheel 104 of bicycle 102 to load carrier 100. In some embodiments, load carrier 100 can include a ratcheting mechanism 300, 500 configured to control rotation of wheel securement arm 200 relative to wheel tray 120. For example, when ratcheting mechanism 300, 500 is engaged, wheel securement arm 200 is prevented from rotating in a first direction 30 but able to rotate in a second direction 40. In some embodiments, when ratcheting mechanism 300, 500 is disengaged, wheel securement arm 200 is free to rotate in the first direction 30 and the second direction 40. In some embodiments, load carrier 100 can include a wheel chock 400 configured to engage with wheel 104 to secure bicycle 102 to load carrier 100.

Load carrier 100 can include a base 110, wheel tray 120, a hub 126, wheel securement arm 200, and ratcheting mechanism 300, as shown, for example, in FIGS. 1–8. In some embodiments, base 110 can include a stinger 106 configured to secure load carrier 100 to a vehicle. In some embodiments, load carrier 100 can be a bicycle carrier 100 such that wheel 104 of bicycle 102 is supported by wheel tray 120 and secured by wheel securement arm 200. In some embodiments, load carrier 100 can be configured to secure one or more bicycles and include at least one wheel tray 120 for each wheel 104 of the one or more bicycles 102 and at least one wheel securement arm 200 for each of the one or more wheels 104. In the illustrative embodiment shown in FIG. 1, load carrier 100 includes four wheel trays 120 and four wheel securement arm 200 to secure at least two bicycles to the load carrier 100.

In the illustrative embodiments shown in FIG. 1, wheel trays 120 can couple to a first side 112 of base 110 and a second side 114 of base 110. In some embodiments, wheel trays 120 can extend approximately perpendicular from base 110. In some embodiments, wheel tray 120 can include a proximal end 122, a distal end 124. Proximal end 122 of wheel tray 120 can couple to base 110. Distal end 124 can be opposite proximal end 122 and spaced apart from base 110. In some embodiments, wheel tray 120 can include a groove 125 that extends from proximal end 122 to distal end 124 and sized to receive wheel 104 of a bicycle 102.

In some embodiments, hub 126 can couple to distal end 124 of wheel tray 120 as shown, for example, in FIGS. 1–3B. In some embodiments hub 126 can be part of wheel tray 120 and be disposed at distal end 124 of wheel tray 120. In some embodiments, hub 126 can be an attachment point for wheel securement arm 200 such that wheel securement arm 200 rotates about an axis 128 extending through hub 126. In some embodiments, hub 126 can be substantially hollow and configured to receive at least a portion of ratcheting mechanism 300. In the illustrative embodiment shown in FIGS. 1–3B, hub 126 has a cylindrical shape. In some embodiments, hub 126 can have a polygonal cross-sectional shape.

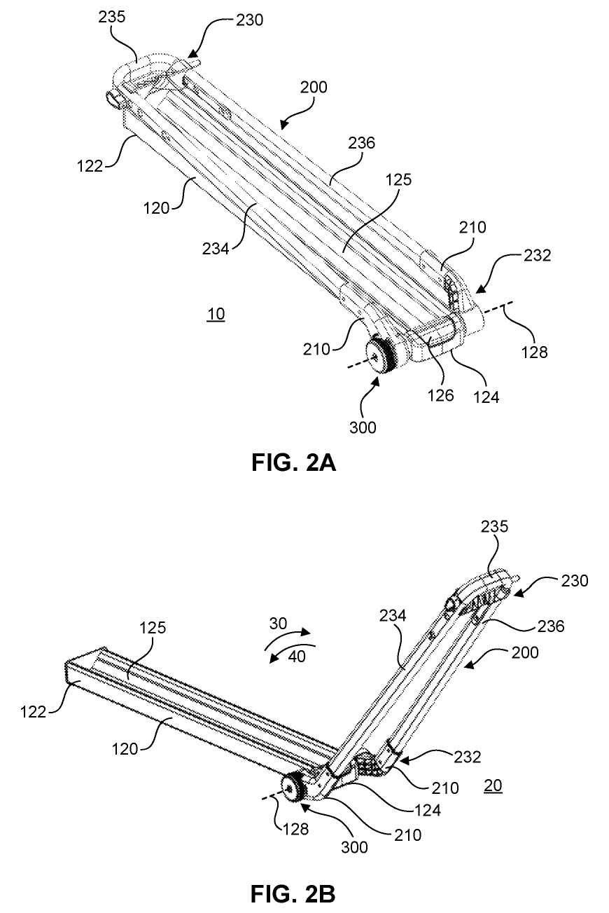

Wheel securement arm 200 can be coupled to wheel tray 120 at hub 126 as shown, for example, in FIGS. 1–2B. Wheel securement arm 200 can be configured to secure wheel 104 to load carrier 100. Wheel securement arm 200 can be configured to rotate about axis 128 form a first position 10 to a second position 20. In some embodiments, first position 10 can be a closed configuration such that wheel securement arm 200 is approximately parallel to wheel tray 120, as shown, for example, in FIG. 2A. In some embodiments, second position 10 can be a loading configuration such that wheel securement arm 200 is rotated outwardly away from wheel tray 120 such that a bicycle 102 can be loaded on to load carrier 100, as shown, for example, in FIG. 2B. In some embodiments, wheel securement arm 200 can be configured to rotate beyond second position 20 beyond a parallel orientation relative to wheel tray 120.

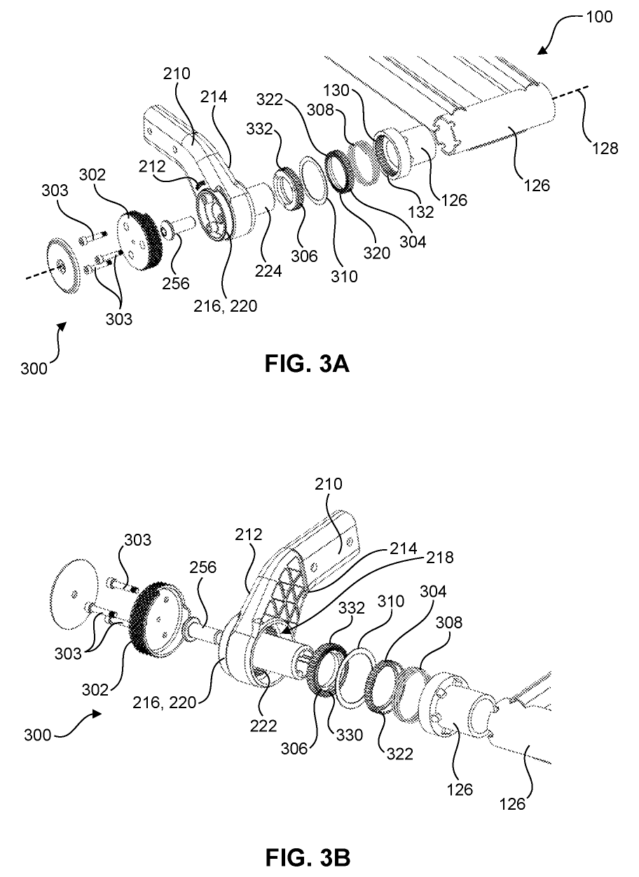

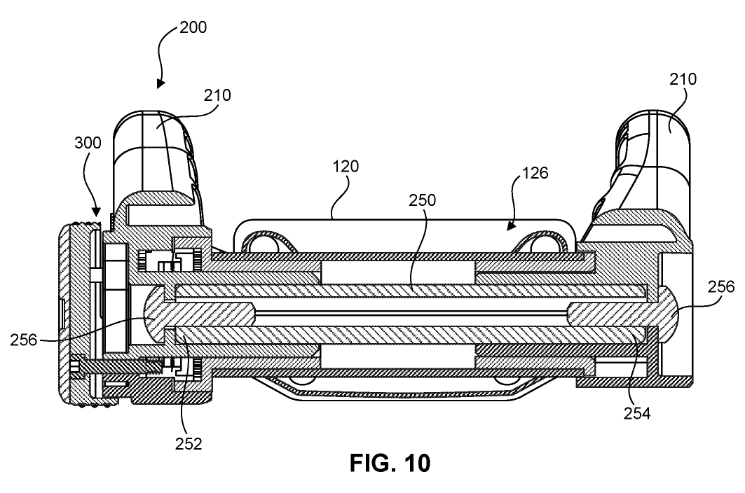

Wheel securement arm 200 can include a distal end 230, a fixed end 232, a bridge 235, a first arm 234, and a second arm 236, as shown, for example, in FIGS. 2A, 2B, and 10. In some embodiments, wheel securement arm 200 can rotatably couple to wheel tray 120 at fixed end 232. The pair of upright arms (e.g., first arm 234 and second arm 236) can extend from the fixed end 232 to the distal end 230. In some embodiments, bridge 235 can extend from the first arm 234 to the second arm 236 to couple first and second arms 234, 236 together at distal end 230. In some embodiments, wheel securement arm 200 can include an arm base 210 at fixed end 232 of first arm 234 and/or the second arm 236 as shown, for example, in FIGS. 3A, 3B, 5A, 5B, 6A, and 6B. In some embodiments, arm base 210 can be integral with either or both of the pair of upright arms 234, 236. In some embodiments, arm base 210 can couple with first arm 234 and/or second arm 236 via welding, adhesive, fasteners, or any other suitable type of coupling arrangement. In some embodiments, arm base 210 can couple to wheel tray 120 at hub 126.

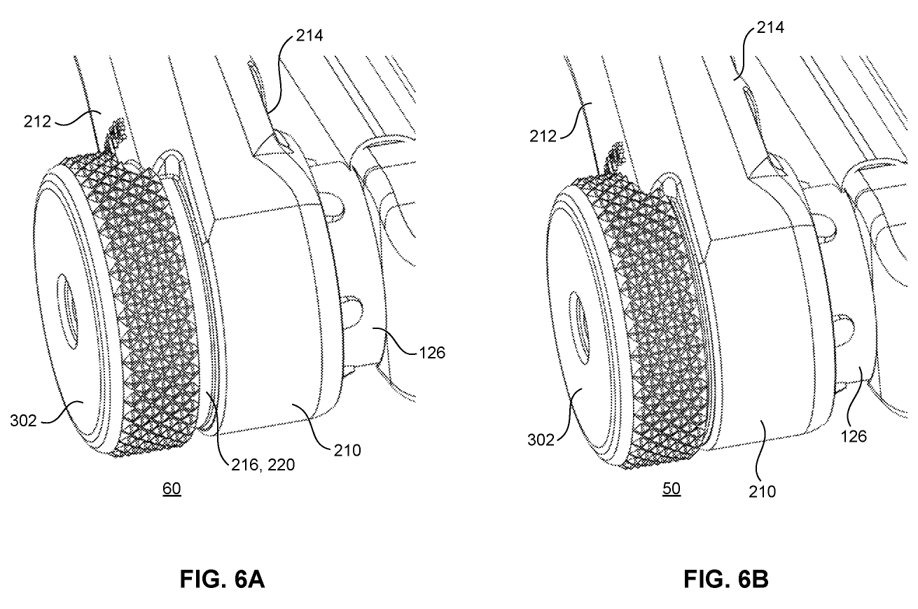

Arm base 210 can include a first side 212 and a second side 214 opposite first side 212 as shown, for example, in FIGS. 3A, 3B, 6A, and 6B. In some embodiments, first side 212 can face outwardly away from wheel tray 120 and second side 214 can face towards wheel tray 120. In some embodiments, first side 212 can include a rim 216 extending outward away from arm base 210. Rim 216 can include an indicator 220 to indicate whether ratcheting mechanism 300 is engaged or disengaged. In some embodiments, indicator 220 can be a different color than arm base 210 such that it is easily visible when uncovered. In some embodiments, indicator 220 can be yellow, red, or any other color that promotes visibility of rim 216 to a user. In some embodiments, indicator 220 can include one or more lights spaced apart around rim 216 and activated when ratcheting mechanism is engaged or disengaged.

In some embodiments, a cavity 218 can be formed in arm base 210, for example, in second side 214. In some embodiments, a portion of ratcheting mechanism 300 can be disposed in cavity 218. In some embodiments, a portion of arm base 210 can extend over and contact a portion of hub 126 such that when wheel securement arm 200 is moved relative to wheel tray 120, friction between arm base 210 and hub 126 slows movement of wheel securement arm 200 in the first and second directions 30, 40.

Ratcheting mechanism 300 can couple to hub 126 as shown, for example, in FIGS. 3A and 3B. Ratcheting mechanism 300 can control rotation of wheel securement arm 200 relative to wheel tray 120. For example, when ratcheting mechanism 300 is in an engaged position 50, ratcheting mechanism 300 can be configured to prevent wheel securement arm 200 from moving in a first direction 30 (e.g. from the first position 10 to the second position 20) and allow wheel securement arm 200 to move in a second direction 40 (e.g. from the second position 20 to the first position 10). In some embodiments, when ratcheting mechanism 300 is in disengaged position 60, ratcheting mechanism 300 can allow wheel securement arm 200 to move freely in both the first and second directions 30, 40.

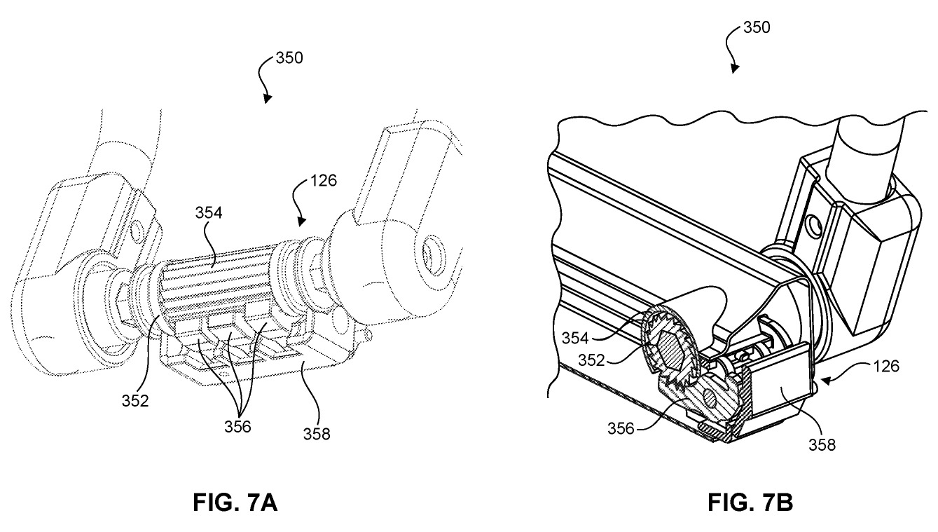

Ratcheting mechanism can include an actuator 302, a first toothed ring 304, a second toothed ring 306, a spring 308, and/or a spacer ring 310 as shown, for example, in FIGS. 3A–6B. In some embodiments, ratcheting mechanism 300 can be at least partially disposed in hub 126 and/or partially disposed in cavity 218 of arm base 210. In some embodiments, ratcheting mechanism 300 can be fully disposed within hub 126 as shown, for example, in FIGS. 7A and 7B. Actuator 302 can be configured to move ratcheting mechanism 300 from an engaged position 50 to a disengaged position 60. In some embodiments, actuator 302 can be disposed on first side 212 of arm base 210.

In the illustrative embodiment shown in FIGS. 6A and 6B, actuator 302 can translate away from and towards arm base 210. In some embodiments, actuator 302 can be coupled to second toothed ring 306 by a plurality of fasteners 303. In some embodiments, plurality of fasteners 303 extend through arm base 210. In some embodiments, actuator 302 can be moved away from arm base 210 to move ratcheting mechanism 300 into the disengaged position 60. In some embodiments, actuator 302 can be pulled away from arm base 210 to move ratcheting mechanism 300 into the disengaged position 60. In some embodiments, actuator 302 can hold ratcheting mechanism 300 in the disengaged position 60 such that a user can move wheel securement arm 200 while ratcheting mechanism 300 is disengaged. In some embodiments, friction between fasteners 303 and arm base 210 can temporarily hold actuator 302 outwardly away from arm base 210 such that ratcheting mechanism is held in the disengaged position 60.

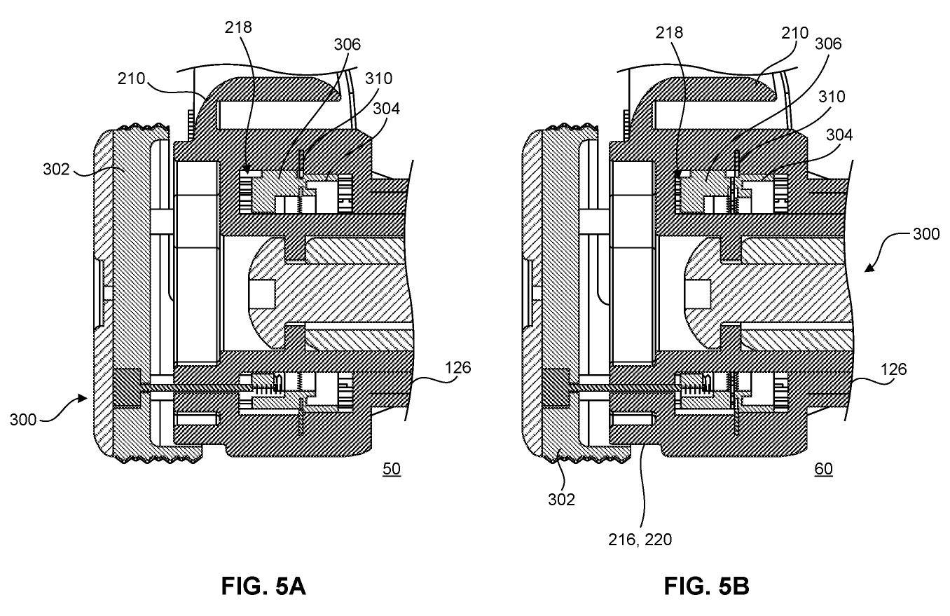

In some embodiments, actuator 302 can be moved towards arm base 210 to move ratcheting mechanism 300 into the engaged position 50 as shown, for example, in FIGS. 5A-6B. In some embodiments, actuator 302 can be pushed towards arm base 210 to move ratcheting mechanism 300 into the engaged position 50 when wheel securement arm 200 is in second position 20. In some embodiments, actuator 302 can automatically move from the disengaged position 60 into the engaged position 50 when wheel securement arm 200 is moved into second position 20.

In the illustrative embodiment shown in FIG. 6B, actuator 302 extends over and covers rim 216 when ratcheting mechanism 300 is in engaged position 50 such that indicator 220 is not visible to a user. In the illustrative embodiment shown in FIG. 6A, actuator 302 moves away from arm base 210 to uncover rim 216 when ratcheting mechanism 300 is in disengaged position 60 such that indicator 220 is visible to a user. Indicator 220 may be beneficial because it allows a user to quickly and easily see whether ratcheting mechanism 300 is disengaged, and bicycle 102 is not properly secured to load carrier 100.

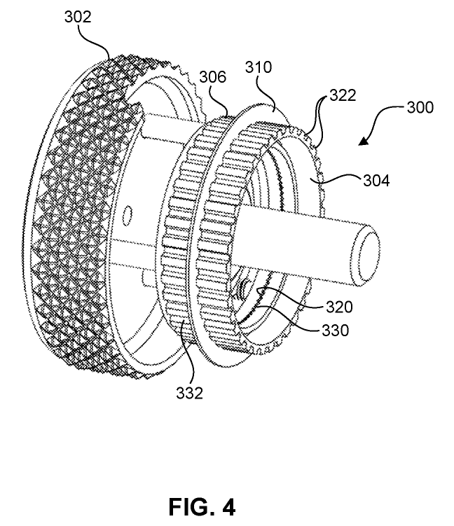

In the illustrative embodiment shown in FIGS. 3A, 3B, 5A, and 5B, first toothed ring 304 is disposed in hub 126. First toothed ring 304 can include a plurality of teeth 320. In some embodiments, the plurality of teeth 320 of first toothed ring 304 can be configured to engage a plurality of teeth 330 of second toothed ring 306. In some embodiments, plurality of teeth 320 can extend axially away from first toothed ring 304 along axis 128. In some embodiments, plurality of teeth 320 can extend radially away from first toothed ring 304 and, for example, engage pawls disposed in cavity 218 of arm base 210. In the illustrative embodiment shown in FIGS. 3A–4, first toothed ring 304 includes radial splines 322. In some embodiments, radial splines 322 can be configured to engage with corresponding interior splines 130 in hub 126. Radial splines 322 and interior splines 130 can be configured to prevent rotation of first toothed ring 304 relative to hub 126 while allowing axial translation of first toothed ring 304 along axis 128 relative to hub 126.

In the illustrative embodiment shown in FIGS. 3A, 3B, 5A, and 5B, second toothed ring 306 is disposed in cavity 218 of arm base 210. Second toothed ring 306 can include plurality of teeth 330 that are configured to engage the plurality of teeth 320 of first toothed ring 304. In some embodiments, plurality of teeth 320, 330 are angled such that when ratcheting mechanism 300 is in engaged position 50, the teeth 320, 330 can slip past each other when wheel securement arm 200 is moved in second direction 40, but teeth 320, 330 lock together and prevent rotation of wheel securement arm 200 in the first direction 30. In some embodiments, plurality of teeth 330 can extend axially away from second toothed ring 306 toward hub 126. In some embodiments, plurality of teeth 330 can extend radially away from second toothed ring 306 and engage pawls disposed in cavity 218 of arm base 210. In the illustrative embodiment shown in FIGS. 3A–4, second toothed ring 306 includes radial splines 332. In some embodiments, radial splines 332 can be configured to engage with corresponding splines 222 in cavity 218. Radial splines 332 and splines 222 can be configured to prevent rotation of second toothed ring 306 relative to arm base 210 while allowing axial translation of second toothed ring 306 along axis 128 relative to arm base 210. In some embodiments, actuator 302 can be coupled to second toothed ring 306 and configured to move second toothed ring 306 away from first toothed ring 304 such that plurality of teeth 320, 330 become disengaged, and ratcheting mechanism is moved into disengaged position 60.

In some embodiments, plurality of teeth 320, 330 can include between 60 and 200 teeth on each of first and second toothed rings 304, 306. In some embodiments, plurality of teeth 320, 330 can include between 70 and 180 teeth on each of first and second toothed rings 304, 306. In some embodiments, plurality of teeth 320, 330 can include between 80 and 110 teeth on each of first and second toothed rings 304, 306. In some embodiments, plurality of teeth 320, 330 can include 90 teeth on each of first and second toothed rings 304, 306. An increased number of teeth can increase angular engagement between first toothed ring 304 and second toothed ring 306 such that distal end 230 of wheel securement arm 200 moves a shorter distance between engagement of adjacent teeth of the plurality of teeth 320, 330 at hub 126. In some embodiments, the number of teeth can be increased by increasing a diameter of first and second toothed rings 304, 306. In some embodiments, the number of teeth can be increased by using narrower cut teeth on the first and second toothed rings 304, 306, thereby reducing a pitch length of the plurality of teeth 320, 330.

In some embodiments, ratcheting mechanism 300 can include a third toothed ring radially inward of first toothed ring 304 such that both first toothed ring 304 and third toothed ring engage second toothed ring 304. In some embodiments, third toothed ring can include a plurality of teeth offset, for example, by half a pitch length, from plurality of teeth 320 of first toothed ring 304 to effectively double the engagement with plurality of teeth 330 of second toothed ring 306.

In some embodiments, spring 308 can be disposed between first toothed ring 304 and hub 126, as shown, for example, in FIGS. 3A and 3B. In some embodiments, spring 308 can be configured to bias first toothed ring 304 toward and into engagement with second toothed ring 306. In some embodiments, spring 308 can be disposed in cavity 218 of arm base 210 and configured to bias second toothed ring 306 toward first toothed ring 304.

In the illustrative embodiment shown in FIGS. 4–5B, spacer ring 310 can be disposed between hub 126 and arm base 210. In some embodiments, spacer ring 310 can limit movement of first toothed ring 304. For example, when actuator 302 moves second toothed ring 306 away from first toothed ring 304 and into disengaged position 60, spacer ring 310 can prevent first toothed ring 304 from following second toothed ring 306, thereby forming a gap between plurality of teeth 320, 330 for first and second toothed rings 304, 306. In some embodiments, spacer ring 310 extends over open ends 132 of interior splines 130 in hub 126 such that radial splines 322 of first toothed ring 304 engage spacer ring 310 when first toothed ring 304 reaches the outer boundary of hub 126. In some embodiments, spacer ring 310 prevents further outward movement of first toothed ring 304 such that actuator 302 can move second toothed ring 306 out of engagement with first toothed ring 304 and ratcheting mechanism 300 into disengaged position 60.

As shown, for example, in FIG. 5A, ratcheting mechanism 300 is in engaged position 50 such that actuator 302 pushes second toothed ring 306 toward first toothed ring 304 and toothed rings 304, 306 are engaged. As wheel securement arm 200 is moved in second direction 40, first toothed ring 304 can translate axially away from second toothed ring 306 as plurality of teeth 320, 330 slip past each other. Spring 308 can bias first toothed ring 304 back toward second toothed ring 306 after the plurality of teeth have slipped. As wheel securement arm 200 is moved in first direction 30, first toothed ring 304 is biased toward second toothed ring 306 to lock and maintain engagement between plurality of teeth 320, 330 to prevent rotation in first direction 30. In the illustrative embodiment shown in FIG. 5B, ratcheting mechanism 300 is in disengaged position 60 such that actuator 302 moves second toothed ring 306 out of engagement with first toothed ring 304 and forms a gap between plurality of teeth 320, 330. Spring 308 biases first toothed ring 304 outward, but spacer ring 310 limits movement of first toothed ring 304, maintains the gap between teeth 320, 330, and prevents engagement of first toothed ring 304 and second toothed ring 306.

In the illustrative embodiment shown in FIGS. 7A and 7B, ratcheting mechanism 350 is disposed entirely within hub 126. Ratcheting mechanism 350 can include ratchet wheel 352, a plurality of radial extending teeth 354, a plurality of pawls 356, and/or ratchet body 358. In some embodiments, plurality of teeth 354 extend radially away from ratchet wheel 352. In some embodiments, plurality of pawls 356 are configured to engage with plurality of teeth 354 when ratcheting mechanism 350 is in an engaged position. In some embodiments, the plurality of pawls 356 can be biased (e.g., with a spring) into engagement with plurality of teeth 354. In some embodiments, the plurality of pawls 356 includes three pawls. In some embodiments, the plurality of pawls 356 includes less than three pawls or more than three pawls. In some embodiments, plurality of pawls 356 are axially spaced apart along the length of ratchet wheel 352. In some embodiments, plurality of pawls 356 are circumferentially offset relative to ratchet wheel 352, for example, by a half or a third of a pitch length of adjacent teeth 354, to increase a number of pawl 356 engagements with plurality of teeth 354. In some embodiments, plurality of pawls 356 are movably coupled to ratchet body 358. In some embodiments, ratchet body 358 can be moveably coupled to wheel tray 120 such that ratchet body 358 can be moved away from ratchet wheel 352 to disengage pawls 356 from teeth 354 to move ratcheting mechanism 350 into a disengaged position. Ratcheting mechanism 350 can control movement of wheel securement arm 200 in the first and second directions 30, 40 in a similar manner to ratcheting mechanism 300.

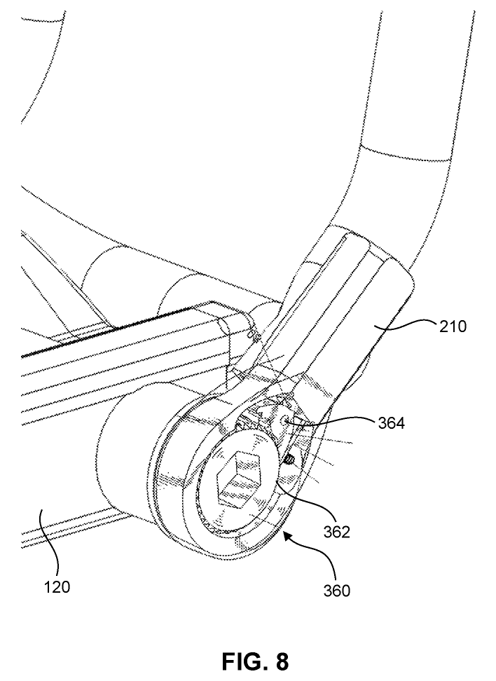

In the illustrative embodiment shown in FIG. 8, ratchet tool mechanism 360 can be coupled to arm base 210. In some embodiments, ratchet tool mechanism 360 can operate similarly to a hand held ratchet tool. Ratchet tool mechanism 360 can include a toothed wheel 362 and a flip chip pawl 364. Flip chip pawl 364 can engage toothed wheel 362 to control rotation of wheel securement arm 200 relative to wheel tray 120. In some embodiments, flip chip pawl 364 can operate to change a direction of the ratchet mechanism such that ratchet tool mechanism 360 can prevent movement of wheel securement arm 200 in both the first and second directions 30, 40. In some embodiments, ratchet tool mechanism 360 can be integral with arm base 210.

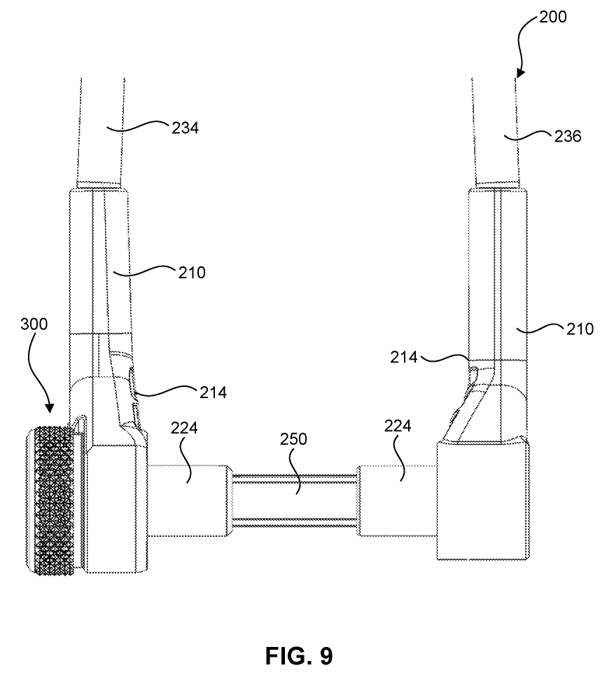

In some embodiments, axle 250 can extend through hub 126 and couple to wheel securement arm 200 as shown, for example, in FIGS. 9-13B. In some embodiments, axle 250 can be part of wheel securement arm 200. In some embodiments, axle 250 can include a first end 252 coupled to first arm 234 and a second end 254 coupled to second arm 236. In some embodiments, axle 250 can be coupled to arm base 210. In some embodiments, bolts 256 extend through first and second arms 234, 236 and into first and second ends 252, 254 of axle 250 to couple axle to the pair of upright arms 234, 236. In some embodiments, axle 250 can extend through hub 126 of wheel tray 120. As shown, for example, in FIGS. 9 and 10, arm base 210 can include a sleeve 224 that extends along a portion of axle 250 and couples therewith. Sleeve 224 can increase a connection length between arm base 210 and axle 250 such that loads from first and second arms 234, 236 can be transferred through axle 250.

Axle 250 can be coupled to first and second arms 234, 236 and configured to rotate with first and second arms 234, 236. In some embodiments, axle 250 can be configured to increase a stiffness and/or strength of wheel securement arm 200 such that wheel securement arm 200 can accommodate increased loads acting on load carrier 100 (e.g. increased weight of bicycle 102 or increased maneuver loads from vehicle movement). In some embodiments, axle 250 can include a cross-sectional shape to increase a torsional stiffness of axle 250 and to transfer loads between arms 234, 236. For example, the cross-sectional shape of axle 250 can be any one of a hexagon, square, or any other suitable polygonal shape. In some embodiments, axle 250 can include protruding or recessed features, for example, extending along the length of axle 250, to increase torsional stiffness and strength of axle 250, such as, for example, splines or grooves. In some embodiments, sleeve 224 can include corresponding features (e.g., shapes, indentations, protrusions) to axle 250 to couple with axle 250 and transfer loads from arms 234, 236 to axle 250.

In some embodiments, for example shown in FIG. 12, wheel securement arm 200 can include brace 260 that extends from the first arm 234 to the second arm 236 and couples the first and second arms 234, 236 together. Brace can be disposed externally to hub 126. In some embodiments, wheel securement arm 200 can include axle 250, brace 260, or both.

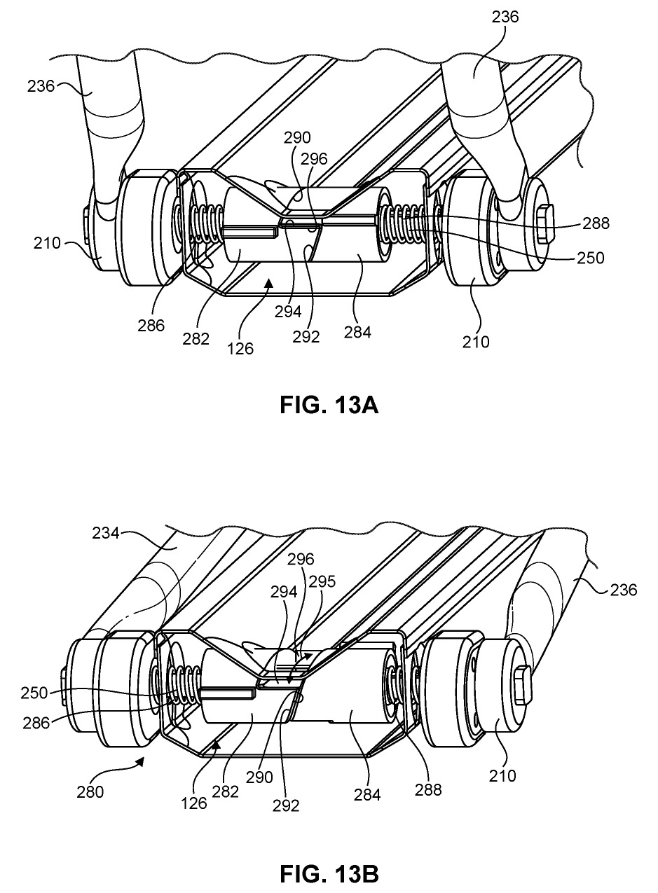

In some embodiments, wheel securement arm 200 can include biasing mechanism 280 as shown, for example, in FIGS. 13A and 13B. Biasing mechanism 280 can be configured to move wheel securement arm 200 from first position 10 to second position 20 without manipulation from a user. Biasing mechanism 280 can be coupled to axle 250 and wheel tray 120 and disposed within hub 126 of wheel tray 120. Biasing mechanism 280 can include a first body 282, a second body 284, a first spring 286, and/or a second spring 288. First body 282 can be coupled with wheel tray 120. In some embodiments, first body 282 can be movably coupled to wheel tray 120 such that first body 282 can translate along axis 128 relative to wheel tray 120, but be rotatably fixed relative to wheel tray 120. Second body 284 can be coupled to axle 250 and configured to rotate with axle 250 and wheel securement arm 200. In some embodiments, second body 284 can translate along axle 250.

In some embodiments, first body 282 of biasing mechanism 280 can include a first sloped end wall 290 that faces and engages a corresponding second sloped end wall 292 of second body 284 as shown, for example, in FIGS. 13A and 13B. First spring 286 can bias first body 282 towards second body 284. Second spring 288 can bias second body 284 towards first body 282. In some embodiments, only one of first body 282 and second body 284 are configured to translate, such that only one of the translating bodies 282, 284 is biased by one of springs 286, 288 towards the other body 282, 284. In some embodiments, the biasing force of springs 286, 288 engage the sloped end walls 290, 292 and cause rotation of first body 282 relative to second body 284. The relative rotation of first body 282 and second body 282 can rotate wheel securement arm 200 relative to wheel tray 120.

In the illustrative embodiment shown in FIG. 13B, wheel securement arm 200 is in first position 10, first sloped end wall 290 engages with second sloped end wall 292, and a circumferential gap 295 exists and extends from stop surface 294 of first body 282 to stop surface 296 of second body 284. Springs 286, 288 bias first and second bodies towards one another such that a reaction force of sloped end walls 290, 292 causes rotation of the bodies 282, 284. The circumferential gap 295 between stop surfaces 294, 296 closes as first and second bodies 282, 284 rotate. As shown, for example, in FIG. 13A, stop surfaces 294, 296 engage to stop rotation of first and second bodies 282, 284 when wheel securement arm 200 is in second position 20.

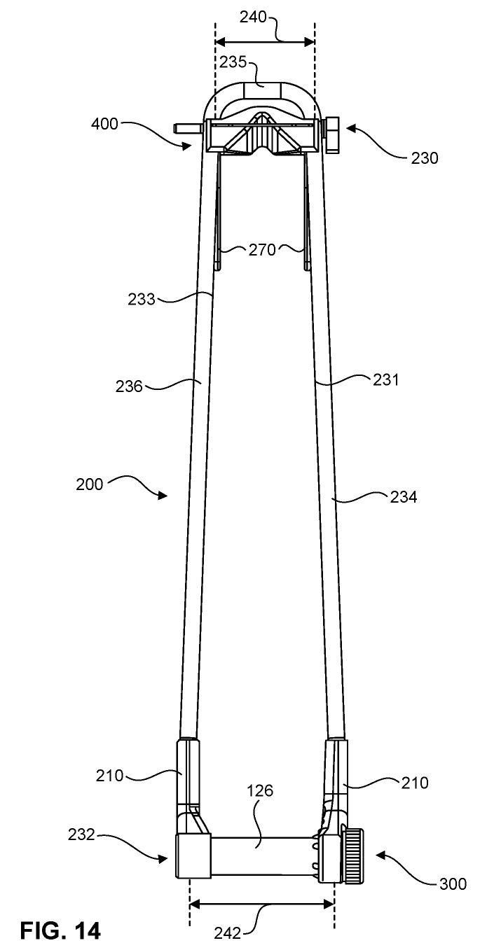

As shown, for example, in FIG. 14, wheel securement arm 200 can have a tapered shape from distal end 230 to fixed end 232. First arm 234 and second arm 236 can be spaced apart between distal end 230 and fixed end 232. In some embodiments, first arm 234 and second arm 236 are non-parallel. In some embodiments, first arm 234 and second arm 236 extend at an angle relative to one another between fixed end 232 and distal end 230. An interior surface 231 of first arm 234 can be spaced apart from an interior surface 233 of second arm 236 at distal end 230 by a first width 240. Interior surface 231 of first arm 234 can be spaced apart from interior surface 233 of second arm 236 at fixed end 232 by a second width 242. In some embodiments, first width 240 can be less than second width 242 such that wheel securement arm 200 narrows towards distal end 230. In some embodiments, first arm 234 and second arm 236 extend linearly from distal end 230 to fixed end 232 without any bends in either arm. In some embodiments, first arm 234 and second arm 236 can be connected with bridge 235 at distal end 230. In some embodiments, bridge 235 forms a continuous arc extending from first arm 234 to second arm 236. In some embodiments, bridge 235 forms a flattened arc profile.

In some embodiments, the tapered shape of wheel securement arm 200 can provide similar structural benefits to the spokes of a bicycle wheel. For example, if a load secured by wheel securement arm 200 leans or exerts a force outwardly on first arm 234 or second arm 236 causing a compressive force on first arm 234 or second arm 236, the resultant force on the opposite arm 234, 236 will be a tension force in the opposite arm 234, 236, which can typically can be accommodated more easily by arms such as first arm 234 and/or second arm 236. In some embodiments, the combination of axle 250, u-shaped portion 235, and non-parallel arms 234, 236 forming the tapered shape, can increase the overall strength and stiffness of wheel securement arm 200.

Wheel chock 400 is moveably coupled to wheel securement arm 200 as shown, for example, in FIGS. 14-19. Wheel chock 400 can be translated along first and second arms 234, 236 to accommodate different sized wheels 104 (e.g., 24 inch wheels, 27.5 inch wheels, and 29 inch wheels). Due to the tapered shape of wheel securement arm 200, in some embodiments, wheel securement arm 200 can include tapered inserts 270 to facilitate parallel sliding surface 272 on which wheel chock 400 can move. Tapered inserts 270 are coupled to each of first arm 234 and second arm 236. In some embodiments, tapered inserts 270 are coupled to each of first arm 234 and second arm 236 by welding, adhesive, bolts, snap-fit connectors, or any other suitable connecting method.

Tapered inserts 270 can include inward facing surface 272, a plurality of apertures 274, a plurality of protrusions 276, first end 277, and/or second end 278 as shown, for example in FIGS. 14-16B. Inward facing surfaces 272 provide a sliding surface on which wheel chock 400 translates. First end 277 of tapered inserts 270 can be disposed closer to distal end 230 of wheel securement arm 200 than second end 278. First end 277 of tapered inserts 270 can have a first thickness less than a second thickness of second end 278. In some embodiments, protrusions 276 extend inwardly from inward facing surfaces 272 and are configured to engage with protrusions 405 of wheel chock 400. In some embodiments, protrusions 276 temporarily hold wheel chock 400 in a plurality of positions when securement bar 430 is not assembled. In some embodiments, protrusions 276 can facilitate one-handed operation and movement of wheel chock 400 along wheel securement arm 200. In some embodiments, one or more apertures 274 are formed in tapered inserts 270. In some embodiments, apertures 274 align with apertures 238 formed in first and second arms 234, 236. In some embodiments, apertures 238, 274 are configured to receive securement bar 430 to secure wheel chock 400 in a position that corresponds to a wheel size of a wheel 104 being secured to load carrier 100.

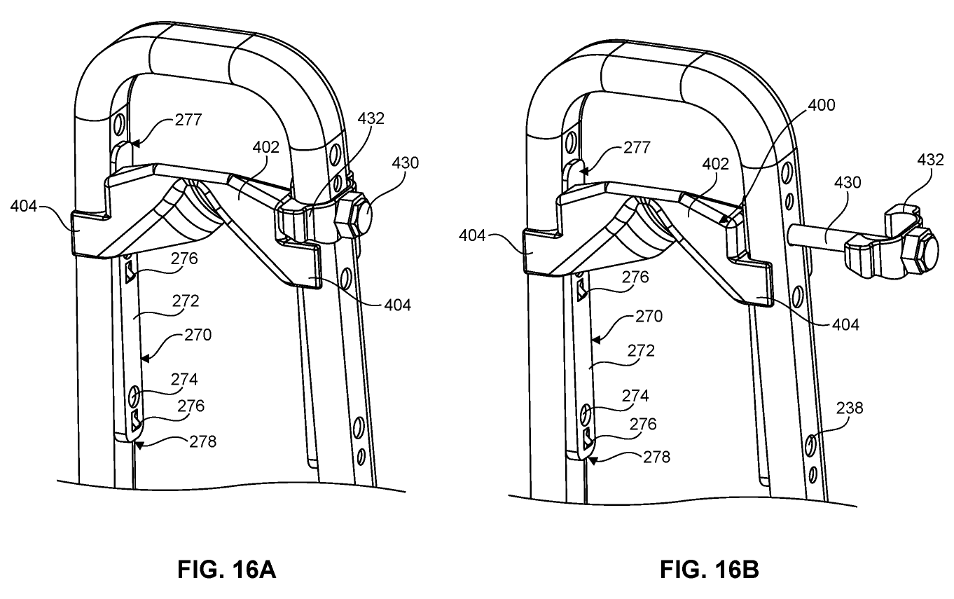

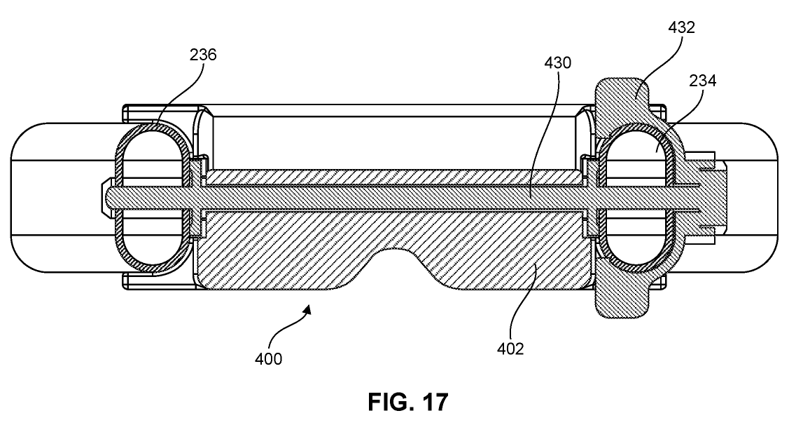

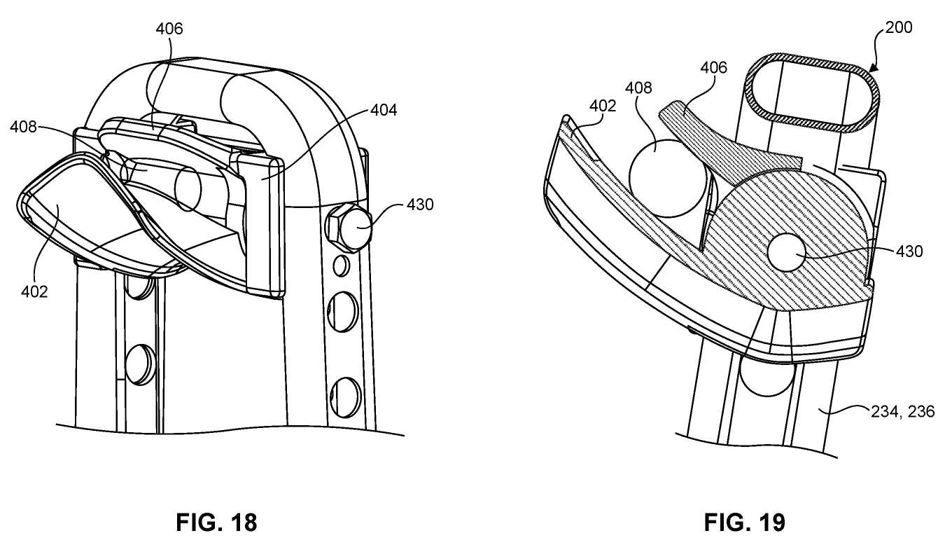

In the illustrative embodiment shown in FIGS. 16A-17, wheel chock 400 can include a securement bar 430, a wheel receiving body 402, and/or arm guide 404. Securement bar 430 can extend through apertures 238, 274 in first arm 234, through wheel receiving body 402 of wheel chock 400, and through apertures 238, 274 in second arm 236 to secure wheel chock 400 to wheel securement arm 200. In some embodiments, securement bar 430 can include clamp 432 that extends around at least a portion of a perimeter one of first arm 234 or second arm 236. Clamp 432 can be configured to secure securement bar 430 to wheel securement arm 200 and prevent securement bar 430 from uncoupling from wheel securement arm 200. In some embodiments, clamp 432 can be flexible such that clamp 432 can be deflected outward by a wider portion of first or second arm 234, 236 and then deflected back inward to secure securement bar 430 in position. In some embodiments, securement bar 430 can be threadably coupled to at least one of first or second arms 234, 236. In some embodiments, securement bar 430 can extend through wheel securement arm 200 and include a fastener on the opposite side of wheel securement arm 200 to couple therewith to secure securement bar 430 and wheel chock 400 to wheel securement arm 200.

In some embodiments, one or more arm guides 404 can extend from wheel receiving body 402 as shown, for example, in FIGS. 16A and 16B. Arm guides 404 can extend around at least a portion of a perimeter of first and second arms 234, 236. As shown, for example, in FIG. 16A, guide arms 404 and clamp 432 extend around opposite sides of first arm 234 and partially overlap. In some embodiments, protrusions 405 extend outwardly from guides arms 404 to engage protrusions 276 of tapered inserts to temporarily hold wheel chock 400 relative to wheel securement arm 200 when securement bar 430 is not inserted.

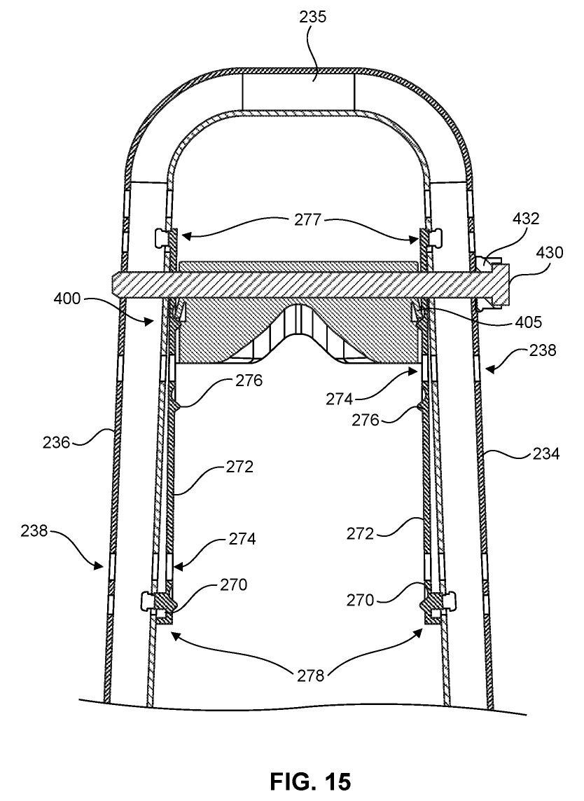

Wheel receiving body 402 can be shaped to receive different types of bicycle wheels 104 as shown, for example, in FIGS. 15-19. For example, wheel receiving body can accommodate a mountain bike wheel, a road bike wheel, a child’s bicycle wheel, a fat bike wheel, or any other type of bicycle wheel and tire configuration. Wheel receiving body 402 can extend between first and second arm 234, 236. In the illustrative embodiment shown in FIGS. 16A and 16B, wheel receiving body 402 can be a single-piece component with fixed orientation relative to wheel securement arm 200.

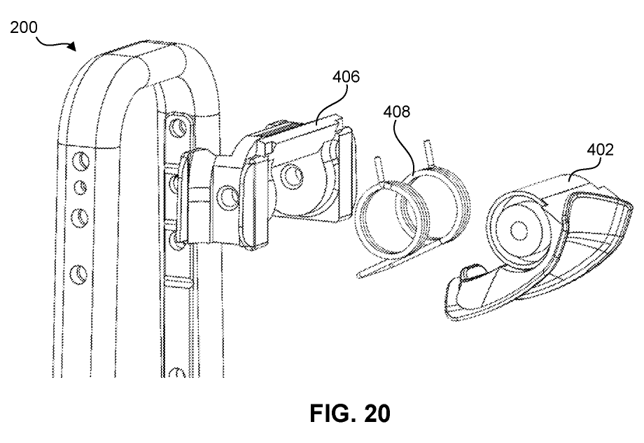

In the illustrative embodiment shown in FIGS. 18 and 19, wheel receiving body 402 can be movably mounted to a fixed arm 406. In some embodiments, wheel receiving body 402 can pivot or move in a generally arced shape relative to wheel securement arm 200. In some embodiments, biasing member 408 can be coupled between fixed arm 406 and wheel receiving body 402 and configured to bias wheel receiving body 402 into contact with wheel 104. In some embodiments, biasing member 408 can be at least one of a spring, an airbag, a cushion, a damper, or any other suitable biasing or damping device. As shown, for example, in FIG. 20, spring 408 can be a torsional spring coupled between the wheel receiving body 402 and the fixed arm 406. In some embodiments, torsional spring 408 can be coupled between wheel receiving body 402 and wheel securement arm 200 and configured to rotate wheel receiving body 402 relative to wheel securement arm 200. In some embodiments, wheel receiving body 402 is pivotable about securement bar 430.

In some embodiments, a movable wheel receiving body 402 can be advantageous to accommodate angular slack in wheel securement arm 200 caused by wider angular engagement in ratcheting mechanism 300. For example, if a wheel 104 is positioned on load carrier 100 such that the angle of wheel securement arm 200 relative to wheel tray 120 is in-between engagement of teeth 320, 330 of ratcheting mechanism 300, wheel receiving body 402 can move to allow rotation of wheel securement arm 200 until the next angular engagement of teeth 320, 330 is achieved. Alternatively, wheel receiving body 402 can bias wheel securement arm 200 back to the previous engagement of teeth 320, 330 in ratcheting mechanism 300. Movable wheel receiving body 402 can thereby reduce angular slack between wheel 104 and wheel securement arm 200 to better secure bicycle 102 to load carrier 100.

In some embodiments, to operate wheel chock 400, a user can pull securement bar 430 out of apertures 238, 274 until it is free from the assembly. With the securement bar 430 removed, wheel chock 400 can be temporarily held in position relative to wheel securement arm 200, for example, by protrusions 276 in engagement with protrusions 405. Engagement between protrusions 276, 405 can be easily overcome by the user by urging wheel chock 400 to a desired position along tapered inserts 270 and wheel securement arm 200. At the desired position, protrusions 405 of wheel chock 400 engage the next set of protrusions 276 of tapered inserts 270 to temporarily hold wheel chock 400 in the desired position. The user can re-insert securement bar 430 through wheel securement arm 200 and wheel chock 400 to secure wheel chock 400 in the desired position.

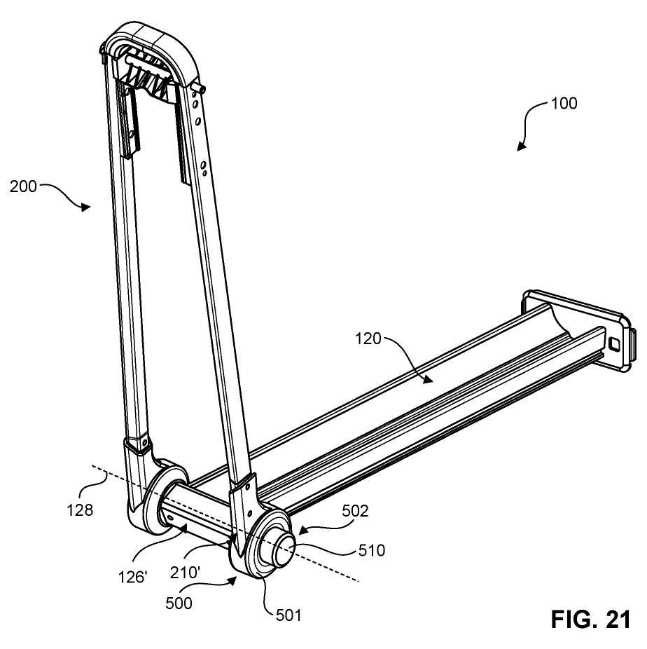

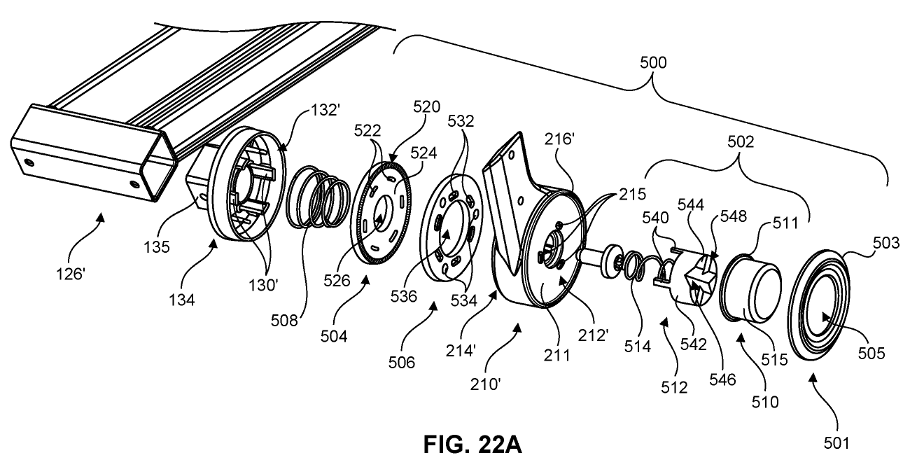

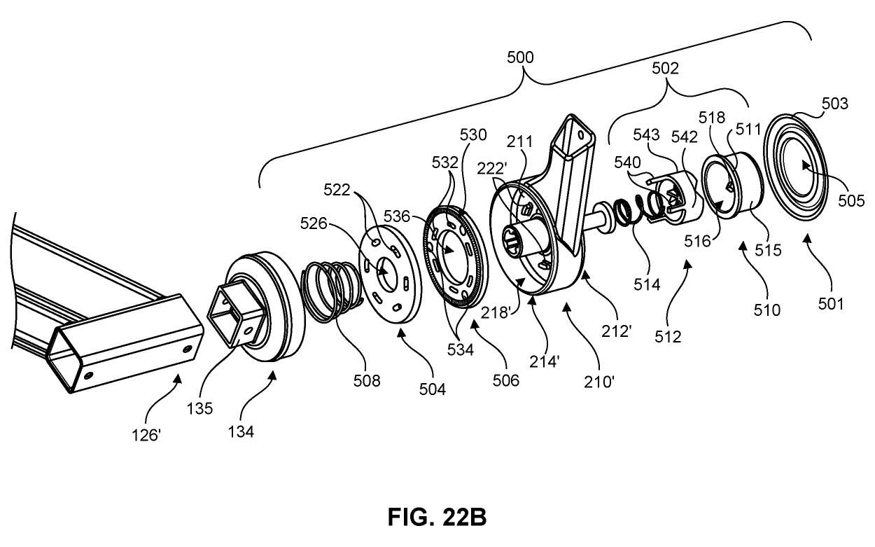

Load carrier 100 can include wheel tray 120, a hub 126´, wheel securement arm 200, and ratcheting mechanism 500, as shown, for example, in FIGS. 21-26. Although ratcheting mechanism 500 is shown in FIGS. 21–26 as a stand-alone system, the embodiments of this disclosure can be used with other apparatuses and/or systems, such as, but not limited to axle 250, brace 260, and wheel chock 400. In some embodiments, hub 126´ can be substantially hollow and configured to receive at least a portion of ratcheting mechanism 500. In the illustrative embodiment shown in FIGS. 22A and 22B, hub 126´ has an approximately square cross-sectional shape. In some embodiments, hub 126´ can have a cylindrical cross-sectional shape or other polygonal cross-sectional shapes. In some embodiments, hub 126´ can couple to distal end 124 of wheel tray 120. In some embodiments, hub 126´ can be part of wheel tray 120 and be disposed at distal end 124 of wheel tray 120. In some embodiments, hub 126´ can be integrally formed at a distal end 124 of wheel tray 120.

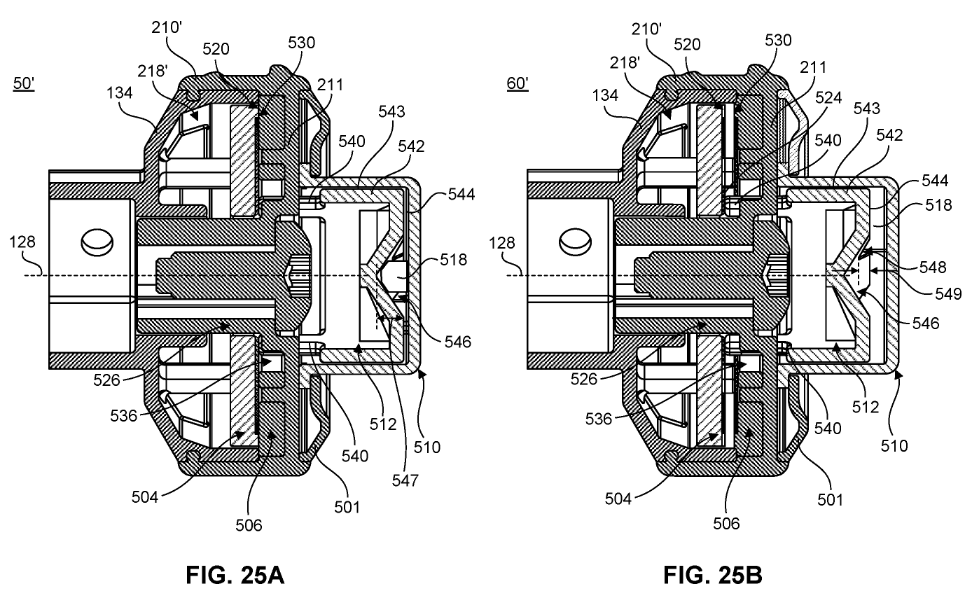

In some embodiments, hub 126´ can include a hub mechanism housing 134 as shown, for example, in FIGS. 22A, 22B, 25A, and 25B. In some embodiments, hub mechanism housing 134 can couple to an end of hub 126´. In some embodiments, hub mechanism housing 134 can have a connecting portion 135 with similar cross-sectional shape to hub 126´ such that torsional loads from hub mechanism housing 134 can be transferred into hub 126´ and wheel tray 120. In some embodiments, connecting portion 135 and hub 126´ can have a square cross-sectional shape, as shown, for example in FIGS. 22A and 22B. In some embodiments, connecting portion 135 and hub 126´ can have any other polygonal cross-sectional shape that prevents relative rotation between hub mechanism housing 134 and hub 126´. In some embodiments, hub 126´ can have a circular cross-section and include a plurality of recesses formed in an end of hub 126´, and connecting portion 135 of hub mechanism housing 134 can include a plurality of protrusions that extends into the plurality of recesses such that torsional loads can be transferred between the hub mechanism housing 135 and hub 126´. Hub mechanism housing 134 can overlap with and extend into a portion of a cavity 218´ of arm base 210´. Hub mechanism housing 134 can contact arm base 210´ such that when wheel securement arm 200 is moved relative to wheel tray 120, friction between arm base 210´ and hub mechanism housing 134 slows movement of wheel securement arm 200 in the first and second directions 30, 40.

In some embodiments, hub mechanism housing 134 can include a plurality of protrusions 130´ and an open end 132´ as shown, for example, in FIG. 22A. Open end 132´ can face arm base 210´ and be configured to receive a first toothed ring 504 of ratcheting mechanism 500. Protrusions 130´ can extend away from hub 126´, toward open end 132´, and be configured to extend through and engage with a plurality of slots 522 in first toothed ring 504. Protrusions 130´ can extend approximately parallel to axis 128 such that first toothed ring 504 can translate, via slots 522, along protrusions 130´ and parallel to axis 128. In some embodiments, the number of protrusions 130´ in hub mechanism housing 134 can correspond to the number of slots 522 in first toothed ring 504. In some embodiments, the plurality of protrusions 130´ can include six protrusions as shown, for example, in FIG. 22A. The number of protrusions 130´ and slots 522 can allow hub mechanism housing 134 to moveably retain first toothed ring 504 and prevent rotation of first toothed ring 504 relative to hub mechanism housing 134 and hub 126´. In some embodiments, the plurality of protrusions 130´ can include less than six protrusions or more than six protrusions.

Wheel securement arm 200 can include an arm base 210´ at fixed end 232 of first arm 234 and/or the second arm 236 as shown, for example, in FIGS. 21, 22A, 22B, 25A, and 25B. Arm base 210´ can include a base wall 211, a first side 212´, and a second side 214´ opposite first side 212´ as shown, for example, in FIGS. 22A, 22B, 25A, and 25B. In some embodiments, first side 212´ can face outwardly away from wheel tray 120 and second side 214´ can face towards wheel tray 120. Base wall 211 can be disposed between first side 212´ and second side 214´. Base wall 211 can include a plurality of apertures 215 extending through base wall 211. The plurality of apertures 215 can be configured to receive legs 540 of a push member 512. In some embodiments, the plurality of apertures 215 can be arranged on base wall 211 in a pattern that corresponds to legs 540 of push member 512. In some embodiments, a lip 216´ extends from first side 212´. Lip 216´ can include a radially inward extending wall configured to retain a cover plate 501 of ratchet mechanism 500.

In some embodiments, a cavity 218´ can be formed in arm base 210´, for example, in second side 214´ as shown, for example, in FIG. 22B. In some embodiments, a portion of ratcheting mechanism 500 can be disposed in cavity 218´. In some embodiments, a plurality of protrusions 222´ extend away from base wall 211 on second side 214´ such that the plurality of protrusions are disposed in cavity 218´. In some embodiments, the plurality of protrusions 222´ are configured to extend through a plurality of slots 532 formed in a second toothed ring 506 of ratchet mechanism 500. In some embodiments, the plurality of slots 532 can extend approximately parallel to axis 128. In some embodiments, a portion of arm base 210´ can extend over and contact hub mechanism housing 134 of hub 126´ such that when wheel securement arm 200 is moved relative to wheel tray 120, friction between arm base 210´ and hub mechanism housing 134 slows movement of wheel securement arm 200 in the first and second directions 30, 40.

Ratcheting mechanism 500 can couple to arm base 210´ and hub mechanism housing 134 of hub 126´ as shown, for example, in FIGS. 22A and 22B. Ratcheting mechanism 500 can control rotation of wheel securement arm 200 relative to wheel tray 120. For example, when ratcheting mechanism 500 is in an engaged position 50´, ratcheting mechanism 500 can be configured to prevent wheel securement arm 200 from moving in a first direction 30 (e.g. from the first position 10 to the second position 20) and allow wheel securement arm 200 to move in a second direction 40 (e.g. from the second position 20 to the first position 10). In some embodiments, when ratcheting mechanism 500 is in disengaged position 60´, ratcheting mechanism 500 can allow wheel securement arm 200 to move freely in both the first and second directions 30, 40.

Ratcheting mechanism 500 can include cover plate 501, an actuator 502, a first toothed ring 504, a second toothed ring 506, and/or a spring 508 as shown, for example, in FIGS. 21–25B. In some embodiments, ratcheting mechanism 500 can be at least partially disposed in hub mechanism housing 134 of hub 126´ and/or partially disposed in cavity 218´ of arm base 210´. Actuator 502 can be configured to move ratcheting mechanism 500 from an engaged position 50´ to a disengaged position 60´. As shown, for example, in FIGS. 21, 25A, and 25B, cover plate 501 can be attached to first side 212´ of arm base 210´. Cover plate 501 can be retained by lip 216´ such that lip 216´ extends radially inward and overlaps with an outer perimeter 503 of cover plate 501. In some embodiments, cover plate 501 can be coupled to arm base 210´ by fasteners, adhesive, press-fit, or by a joining process such as welding. Cover plate 501 can include an aperture 505 configured to receive at least a portion of actuator 502.

In some embodiments, first toothed ring 504 can be moveably coupled to hub mechanism housing 134 of hub 126´ and be configured to translate within hub mechanism housing 134 along axis 128. First toothed ring 504 can include a plurality of teeth 520, a plurality of slots 522, an actuation surface 524, and an axle aperture 526 as shown, for example, in FIGS. 22A, 22B, and 24A-25B. The plurality of teeth 520 of first toothed ring 504 can be configured to engage a plurality of teeth 530 of second toothed ring 506. In some embodiments, plurality of teeth 520 can extend axially away from first toothed ring 504 approximately parallel to axis 128.

In some embodiments, axle aperture 526 is formed through first toothed ring 504 as shown, for example, in FIGS. 22A and 22B. Actuation surface 524 can extend radially between axle aperture 526 and the plurality of teeth 520. Actuation surface 524 can provide a planar surface that engages legs 540 of a push member 512 of actuator 502. In some embodiments, when actuator 502 is moved, legs 540 contact actuation surface 524 to move first toothed ring 504 to move ratcheting mechanism 500 from the engaged position 50´ to the disengaged position 60´. Axle aperture 526 can have a diameter larger than axle 250 such that axle 250 can extend through axle aperture 526 without contacting first toothed ring 504. In some embodiments, axle aperture 526 can have a diameter less than radial spacing of legs 540 of push member 512, such that push member 512 does not extend through first toothed ring 504 and legs 540 engage actuation surface 524.

In some embodiments, the plurality of slots 522 can be formed through first toothed ring 504 and be configured to receive the plurality of protrusions 130´ of hub mechanism housing 134 as shown, for example, in FIGS. 22A and 22B. Engagement between slots 522 and protrusions 130´ can prevent rotation of first toothed ring 504 relative to hub 126´ while allowing axial translation of first toothed ring 504 along axis 128 relative to hub 126´ and hub mechanism housing 134. In some embodiments, the number of slots 522 can correspond to the number of protrusions 130´. In some embodiments, the plurality of slots 522 can include six slots. In some embodiments, the plurality of slots 522 can include more or less than six slots. In some embodiments, the plurality of slots 522 can be arranged in a pattern on first toothed ring 504 that corresponds to an arrangement of the plurality of protrusions 130´ of hub mechanism housing 134. In some embodiments, slots 522 can be equally spaced circumferentially around first toothed ring 504 and radially spaced apart from axle aperture 526 and the plurality of teeth 520. In some embodiments, each slot of the plurality of slots 522 can have a cross-sectional shape that corresponds to a cross-sectional shape of the plurality of protrusions 130´ and may be one of an elongated arc, a circle, or any other polygonal shape.

In some embodiments, second toothed ring 506 can be fixedly coupled to arm base 210´ and disposed in cavity 218´. Second toothed ring 506 can include a plurality of teeth 530, a plurality of slots 532, a plurality of apertures 534, and an axle aperture 536 as shown, for example in FIGS. 22A, 22B, and 24A-25B. The plurality of teeth 530 can be configured to engage the plurality of teeth 520 of first toothed ring 504 when ratcheting mechanism 500 is in the engaged position 50´. In some embodiments, plurality of teeth 520, 530 are angled such that when ratcheting mechanism 500 is in engaged position 50´, the teeth 520, 530 can slip past each other when wheel securement arm 200 is moved in second direction 40, but teeth 520, 530 lock together and prevent rotation of wheel securement arm 200 in the first direction 30. In some embodiments, plurality of teeth 530 can extend axially away from second toothed ring 506 toward hub 126´ approximately parallel to axis 128. In some embodiments, axle aperture 536 is formed through second toothed ring 506 as shown, for example, in FIGS. 22A and 22B. Axle aperture 526 can have a diameter larger than axle 250 and push member 512 such that axle 250 and push member 512 can freely extend through axle aperture 536 without contacting second toothed ring 506.

In some embodiments, the plurality of slots 532 can be formed through second toothed ring 506 and be configured to receive the plurality of protrusions 222´ of arm base 210´ as shown, for example, in FIGS. 22A and 22B. Engagement between slots 532 and protrusions 222´ can prevent rotation of second toothed ring 506 relative to arm base 210´. In some embodiments, the number of slots 532 can correspond to the number of protrusions 222´. In some embodiments, the plurality of slots 532 can include six slots. In some embodiments, the plurality of slots 532 can include more or less than six slots. In some embodiments, the plurality of slots 532 can be arranged in a pattern on second toothed ring 506 that corresponds to an arrangement of the plurality of protrusions 222´ of arm base 210´. In some embodiments, slots 532 can be equally spaced circumferentially around second toothed ring 506 and radially spaced apart from axle aperture 536 and the plurality of teeth 530. In some embodiments, each slot of the plurality of slots 532 can have a cross-sectional shape that corresponds to a cross-sectional shape of the plurality of protrusions 222´ and can be one of an elongated arc, a circle, or any other polygonal shape.

In some embodiments, the plurality of apertures 534 can be formed through second toothed ring 506 as shown, for example, in FIGS. 22A and 22B. In some embodiments, the plurality of apertures 534 can be configured to receive fasteners that attach second toothed ring 506 to arm base 210´. In some embodiments, the plurality of apertures 534 can include one, two, three, or more than three apertures. In some embodiments, second toothed ring 506 can be fixedly coupled to arm base 210´ by a plurality of bolts, rivets, or other similar fasteners. In some embodiments, second toothed ring 506 can be adhered, bonded, or joined to arm base 210´.

In some embodiments, plurality of teeth 520, 530 can include between 60 and 250 teeth on each of first and second toothed rings 504, 506. In some embodiments, plurality of teeth 520, 530 can include between 70 and 200 teeth on each of first and second toothed rings 504, 506. In some embodiments, plurality of teeth 520, 530 can include 180 teeth on each of first and second toothed rings 504, 506. An increased number of teeth may be beneficial to increase angular engagement between first toothed ring 504 and second toothed ring 506 such that distal end 230 of wheel securement arm 200 moves a shorter distance between engagement of adjacent teeth of the plurality of teeth 520, 530 at hub 126´. In some embodiments, the number of teeth can be increased by increasing a diameter of first and second toothed rings 504, 506. In some embodiments, the number of teeth can be increased by using narrower cut teeth on the first and second toothed rings 504, 506, thereby reducing a pitch length of the plurality of teeth 520, 530. In some embodiments, each tooth of the plurality of teeth 520, 530 can include a negative angle on an engagement side of each tooth. The negative angle on the engagement side of the teeth 520, 530 may be beneficial to pull the first and second toothed rings 504, 506 together when the teeth 520, 530 contact each other as the ratcheting mechanism 500 moves into the engaged position 50´.

In some embodiments, spring 508 can be disposed between first toothed ring 504 and hub mechanism housing 134, as shown, for example, in FIGS. 22A and 22B. In some embodiments, spring 508 can be configured to bias ratcheting mechanism 500 into the engaged position 50´. In some embodiments, spring 508 can be configured to bias first toothed ring 504 towards and into engagement with second toothed ring 506.

Actuator 502 can include an actuator button 510, a push member 512, and a spring 514, as shown for example, in FIGS. 22A-25B. In some embodiments, actuator button 510 can be moveably coupled arm base 210´ on first side 212´. Actuator button 510 can be moveably retained on first side 212´ of arm base 210´ by cover plate 501. Actuator button 510 can include a lip 511, a body 515, a cavity 516, and actuation protrusions 518 disposed in cavity 516 as shown, for example in FIGS. 22A, 22B, 23, 25A, and 25B. Lip 511 can have a larger diameter than aperture 505 of cover plate 501 and overlap with a portion cover plate 501. Lip 511 can be disposed between base wall 211 and cover plate 501 to retain and attach actuator button 510 to arm base 210´. In some embodiments, body 515 extends through aperture 505 of cover plate 501 and outwardly away from cover plate 501 such that a user can hold and move actuator button 510. In some embodiments, the outer surface of body 515 can be knurled, include grip tape or notches, or include other features that improve a user’s grip of actuator button 510.

Actuator button 510 can be configured to cover push member 512 and rotate relative to push member 512 and arm base 210´. As shown, for example, in FIGS. 22A, 22B, 23, 25A, and 25B, cavity 516 is formed in actuator button 510 and configured to receive a body 542 of push member 512. Actuation protrusions 518 are disposed within cavity 516. In some embodiments, actuator button 510 can include two actuation protrusions 518 equally spaced apart around the circumference of cavity 516. In some embodiments, actuator button 510 can include a single actuation protrusion 518 or more than two actuation protrusions 518. Actuation protrusions 518 are configured to engaged with notches 546, 548 on push member 512 when actuator button 510 is moved relative to push member 512. In some embodiments, actuation protrusions 518 can have a wedge shape that corresponds to wedge shapes of notches 546, 548 and are urged into notches 546, 548 such that actuator button 510 “clicks” or is urged into predefined orientations that correspond to the engaged position 50´ and disengaged position 60´ of ratcheting mechanism 500. In some embodiments, the wedge shape of actuation protrusions 518 can be symmetrical or asymmetrical. In some embodiments, actuation protrusions 518 can have a cylindrical, spherical, square, or other polygonal shape to engage notches 546, 548.

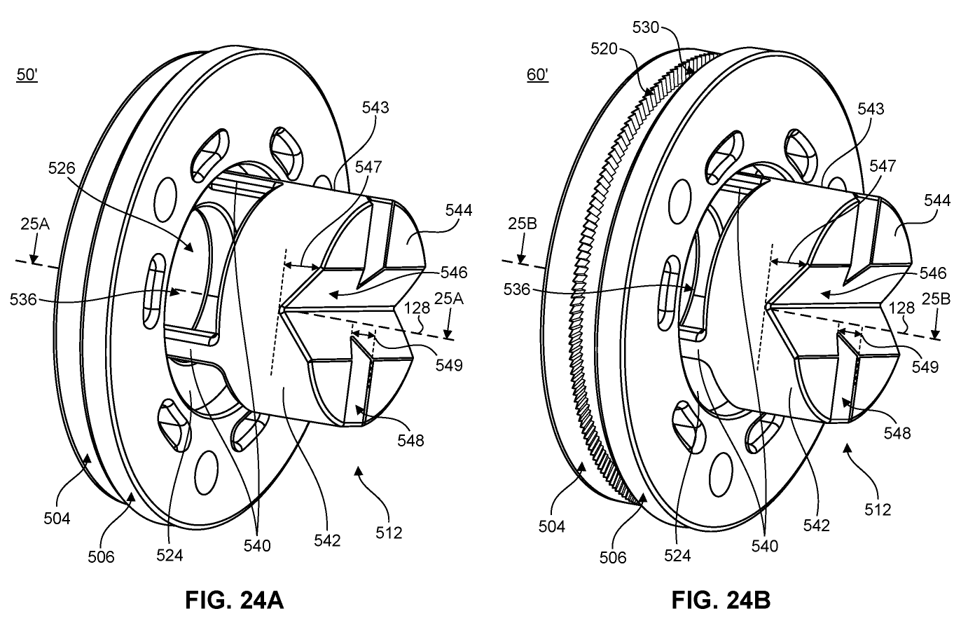

In some embodiments, push member 512 can move first toothed ring 504 away from second toothed ring 506 to move ratcheting mechanism 500 from engaged position 50´ and into disengaged position 60´. As shown, for example, in FIGS. 22A, 22B, 24A, and 24B, push member 512 can include legs 540, body 542, and actuating surface 544. Legs 540 can extend axially away from one side of body 542, and actuating surface 544 can be disposed on the opposite side of body 542. In some embodiments, push member 512 can include three legs 540. As shown, for example, in FIG. 22B, push member 512 includes legs 540 that are equally spaced apart circumferentially around a perimeter edge of push member 512. In some embodiments, push member 512 can include two legs 540 or more than three legs 540. Legs 540 are configured to contact and press against actuation surface 524 of first toothed ring 504. Three or more legs 540 may be beneficial to provide a steady and balanced force onto actuation surface 524 without implementing any rocking effect or moment force.

In some embodiments, legs 540 are approximately aligned with an outer perimeter surface 543 of body 542 in a direction approximately parallel to axis 128. Legs 540 can be spaced to correspond with a plurality of apertures 215 formed in base wall 211 of arm base 210´ such that legs 540 extend through apertures 215. During actuation of ratcheting mechanism 500, legs 540 can freely translate through apertures 215 in base wall 211. With legs 540 disposed in apertures 215, push member 512 can be prevented from rotating relative to arm base 210´. In some embodiments, legs 540 can be spaced circumferentially with a diameter less than axle aperture 536 of second toothed ring 506 such that legs 540 extend through axle aperture 536 of second toothed ring 506. In some embodiments, legs 540 can be spaced circumferentially with a diameter greater than axle aperture 526 of first toothed ring 504 such that legs 540 contact actuation surface 524 of first toothed ring 504 and do not pass through first toothed ring 504. In some embodiments, distal ends of legs 540 can have a small surface area, for example, between approximately 1 mm² and 10 mm², or where a circumferential length of legs 540 are approximately equal to a radial length. In some embodiments, legs 540 can extend further in the circumferential direction than the radial direction to form arc shaped contact areas at the distal ends. Apertures 215 in base wall 211 can have corresponding shape and size to legs 540 to allow legs to freely move within apertures 215 during actuation of ratcheting mechanism 500.

In some embodiments, actuating surface 544 engages with actuator button 510 to convert movement of actuator button 510 into linear movement of push member 512 along axis 128 as shown, for example, in FIGS. 25A and 25B. In some embodiments, when actuator button 510 is rotated about axis 128, push member 512 is translated parallel to axis 128 to move ratcheting mechanism 500 between the engaged position 50´ and disengaged position 60´. Actuating surface 544 can include a first notch 546 and a second notch 548 as shown, for example, in FIGS. 22A, 24A, 24B, 25A, and 25B. First notch 546 and second notch 548 can receive actuation protrusions 518 of actuator button 510 when actuator button 510 is moved relative to push member 512.

In some embodiments, notches 546, 548 extend radially across actuating surface 544 and intersect as shown, for example, in FIGS. 24A and 24B. In some embodiments, notches 546, 548 extend inward from perimeter surface 543 by a distance less than the radius of push member 512 to form discrete notches 546, 548 around the perimeter edge of actuating surface 544. In some embodiments, first notch 546 can be perpendicular to second notch 548 such that actuation protrusions 518 engage with notches 546, 548 in 90 degree intervals. In some embodiments, notches can be arranged in different circumferential orientations to increase or decrease the number of positions that actuation protrusions 518 engage with notches 546, 548.

In some embodiments, first notch 546 can have a first depth 547, and second notch 548 and have a second depth 549 different from first depth 547 as shown, for example, in FIGS. 24A and 24B. In some embodiments, first depth 547 is greater than second depth 549 such that when actuation protrusions 518 are disposed in first notch 546, ratcheting mechanism 500 is disposed in engaged position 50´ (as shown, for example, in FIG. 24A), and when actuation protrusions 518 are disposed in second notch 548, ratcheting mechanism 500 is disposed in disengaged position 60´ (as shown, for example, in FIG. 24B). In some embodiments, first depth 547 of first notch 546 can be between approximately 3 millimeters and approximately 10 millimeters. In some embodiments, first depth 547 of first notch 546 can be between approximately 4 millimeters and approximately 7 millimeters. In some embodiments, first depth 547 of first notch 546 can be approximately 5.5 millimeters. In some embodiments, second depth 549 of second notch 548 can be between approximately 1 millimeter and approximately 5 millimeters. In some embodiments, second depth 549 of second notch 548 can be between approximately 2 millimeters and approximately 4 millimeters. In some embodiments, second depth 549 of second notch 548 can be approximately 2.5 millimeters.

As shown, for example in FIGS. 24A and 24B, notches 546, 548 can have a wedge shape that corresponds to actuation protrusions 518. In some embodiments, the wedge shape of notches 546, 548 can be symmetrical or asymmetrical. For example, an asymmetrical wedge shape of notches 546, 548 and/or actuation protrusions 518 can change the amount of force needed to rotate actuator button 510 and move actuation protrusions 518 in and out of notches 546, 548. This may be beneficial to limit rotational freedom of actuator button 510 relative to arm base 210´, for example, to only move between 0 degree and 90 degrees, or between 0 degrees and 180 degrees. In some embodiments, asymmetrical wedge shapes of notches 546, 548 and/or actuation protrusions 518 can urge a user to rotate actuator button in a clockwise direction and not in a counter-clockwise direction, and vice versa, or prevent rotation in one direction and allow rotation in the opposite direction. In some embodiments, notches 546, 548 can have a cylindrical, spherical, square, or other polygonal shapes to engage actuation protrusions 518.

In some embodiments, spring 514 can be disposed between base wall 211, on first side 212´, and push member 512, as shown, for example, in FIGS. 22A and 22B. In some embodiments, spring 514 can be configured to bias push member 512 towards actuator button 510. IN some embodiments, spring 514 biases push member 512 such that notches 546, 548 and actuating surface 544 remain in constant contact with actuation protrusions 518 of actuator button 510 through all movements of actuator 502. In some embodiments, the force required to rotate actuator button 510 can be increased or reduced by increasing or reducing the force exerted by spring 514 on to push member 512.

As shown, for example, in FIGS. 24A and 25A, ratcheting mechanism 500 is in engaged position 50´ such first toothed ring 504 is biased towards second toothed ring 506 by spring 508 and first toothed ring 504 engages second toothed ring 506.. In the engaged position 50´, actuator button 510 is moved such that protrusions 518 are disposed in first notch 546, and push member 512 is moved toward actuator button 510 and away from hub 126´. In some embodiments, actuator button 510 can be rotated about axis 128 and independently of axle 250 and arm base 210´. When protrusions 518 are disposed in first notch 546, legs 540 of push member 512 are configured to be spaced part from actuation surface 524 of first toothed ring 504, such that first toothed ring 504 engages with second toothed ring 506. As wheel securement arm 200 is moved in second direction 40, first toothed ring 504 can translate axially away from second toothed ring 506, along protrusions 130´ and independent of the position of push member 512, and plurality of teeth 520, 530 can slip past each other. Spring 508 can bias first toothed ring 504 back toward second toothed ring 506 after the plurality of teeth have slipped. As wheel securement arm 200 is moved in first direction 30, first toothed ring 504 is biased toward second toothed ring 506 to lock and maintain engagement between plurality of teeth 520, 530 to prevent rotation in first direction 30.

As shown, for example, in FIGS. 24B and 25B, ratcheting mechanism 500 is in disengaged position 60´ such that push member 512 moves first toothed ring 504 away from second toothed ring 506 to form a gap between plurality of teeth 520, 530. In the disengaged position 60´, actuator button 510 is moved such that protrusions 518 are disposed in second notch 548, and push member 512 is moved toward hub 126´ and away from actuator button 510. In some embodiments, actuator button 510 can be rotated about axis 128 approximately 30 degrees, 45 degrees, 90 degrees, or another angle, to move ratcheting mechanism 500 from engaged position 50´ to disengaged position 60´ or vice versa. When protrusions 518 are disposed in second notch 548, legs 540 of push member 512 are configured to contact actuation surface 524 of first toothed ring 504 and push first toothed ring 504 away from second toothed ring 506. Spring 508 biases first toothed ring 504 toward second toothed ring 506, but push member 512 and legs 540 limit movement of first toothed ring 504, maintain the gap between teeth 520, 530, and prevent engagement of first toothed ring 504 and second toothed ring 506. In some embodiments, actuator button 510 can hold push member 512 in position with first toothed ring 504 spaced apart from second toothed ring 506, such that ratcheting mechanism 500 in disengaged position 60´ allowing a user to freely move wheel securement arm 200.

In some embodiments, ratcheting mechanism 500 can include an indicator that shows a user whether ratcheting mechanism 500 is in engaged position 50´ or disengaged position 60´. For example, actuator button 510 can include an arm 519 extending radially away from actuator button 510. In some embodiments, when arm 519 is aligned and approximately parallel with one of upright arms 234, 236, ratcheting mechanism 500 is in engaged position 50´. In some embodiments, when arm 519 protrudes away from arm base 210´ at an angle to one of upright arms 234, 236, ratcheting mechanism 500 is in disengaged position 60´. When arm 519 protrudes at an angle relative to upright arms 234, 236, a user may notice arm 519 protruding outwardly from arms 234, 236, giving the user a visual indication that ratcheting mechanism 500 is in disengaged position 60´, and wheel securement arm 200 is not securing a wheel 104 of a bicycle 102 properly. In some embodiments, alignment of arm 519 relative to the upright arms 234, 236, can indicate the opposite engagement position 50´, 60´ to that disclosed above. In some embodiments, arm 519 can include a grip portion for user to hold when moving actuator button 510.

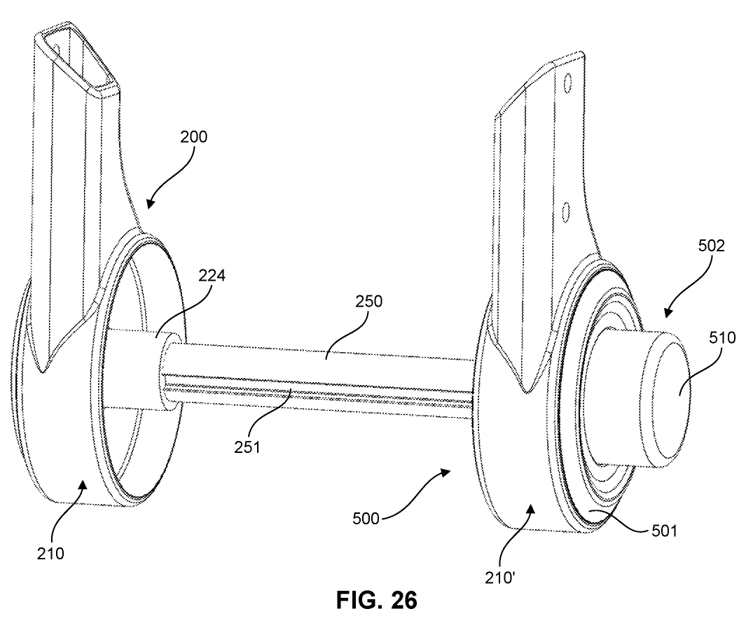

In some embodiments, axle 250 can extend through hub 126´ and couple to wheel securement arm 200 as shown, for example, in FIG. 26. In some embodiments, axle 250 can be coupled to arm base 210´ and ratcheting mechanism 500. In some embodiments, fastener(s) (e.g., bolt(s)) can extend through arm base 210´ and into an end of axle 250 to couple axle 250 to wheel securement arm 200. In some embodiments, axle 250 can extend through hub 126´ of wheel tray 120. As shown, for example, in FIG. 26, arm base 210, 210´ can include a sleeve 224 that extends along a portion of axle 250 and couples therewith. Sleeve 224 can increase a connection length between arm base 210, 210´ and axle 250 such that loads from wheel securement arm 200 can be transferred through axle 250.

Axle 250 can be coupled to wheel securement arm 200 and ratcheting mechanism 500 and configured to rotate with wheel securement arm 200 and a portion of ratcheting mechanism 500. In some embodiments, axle 250 can be configured to increase a stiffness and/or strength of wheel securement arm 200 such that wheel securement arm 200 can accommodate increased loads acting on load carrier 100 (e.g. increased weight of bicycle 102 or increased maneuver loads from vehicle movement). In some embodiments, axle 250 can include a cross-sectional shape that increases a torsional stiffness of axle 250 and transfers loads between arms 234, 236 of wheel securement arm 200. For example, the cross-sectional shape of axle 250 can be any one of a hexagon, square, circle, or any other suitable polygonal shape. In some embodiments, axle 250 can include protruding or recessed features, for example, extending along the length of axle 250, to increase torsional stiffness and strength of axle 250, such as, for example, splines or grooves. As shown, for example, in FIG. 26, axle 26 includes a groove 251 extending along the length of axle 250. In some embodiments, sleeve 224 can include corresponding features (e.g., shapes, indentations, protrusions) to axle 250 to couple with axle 250 and transfer loads from wheel securement arm 200 to axle 250.

It is to be appreciated that the Detailed Description section, and not the Brief Summary and Abstract sections, is intended to be used to interpret the claims. The Summary and Abstract sections may set forth one or more but not all embodiments of the load carrier system and apparatus, and thus, are not intended to limit the present embodiments and the appended claims.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A bicycle carrier, comprising:
a wheel tray configured to support a wheel of a bicycle;
a hub disposed on the wheel tray;
a wheel securement arm coupled to the wheel tray and configured to rotate relative to the wheel tray from a first position to a second position; and
a ratcheting mechanism coupled to the wheel tray and the wheel securement arm and at least partially disposed in the hub, wherein the ratcheting mechanism is configured to control rotation of the wheel securement arm relative to the wheel tray.

2. The bicycle carrier of claim 1, wherein the ratcheting mechanism comprises an actuator configured to move the ratcheting mechanism from an engaged position to a disengaged position.

3. The bicycle carrier of claim 2, wherein the wheel securement arm is configured to move in the first direction when the ratcheting mechanism is in the disengaged position, and the wheel securement arm is blocked from moving in the first direction when the ratcheting mechanism is in the engaged position.

4. The bicycle carrier of claim 1, wherein the wheel securement arm comprises an arm base, and wherein the ratcheting mechanism is at least partially disposed in a cavity formed in the arm base.

5. The bicycle carrier of claim 4, wherein the ratcheting mechanism comprises an actuator configured to move the ratcheting mechanism from an engaged position to a disengaged position, and wherein the actuator is disposed on a first side of the arm base of the wheel securement arm, and wherein the cavity is formed in a second side of the arm base opposite the first side.

6. The bicycle carrier of claim 1, wherein the wheel securement arm comprises an arm base, the arm base comprises a rim having an indicator on a first side of the arm base,
wherein the ratcheting mechanism comprises an actuator configured to move the ratcheting mechanism from an engaged position to a disengaged position, and
wherein the indicator is visible when the actuator moves the ratcheting mechanism into the disengaged position, and wherein the indicator is hidden by the actuator when the ratcheting mechanism is in the engaged position.

7. The bicycle carrier of claim 1, wherein the ratcheting mechanism comprises a first toothed ring movably coupled to the hub.

8. The bicycle carrier of claim 7, wherein the first toothed ring comprises a plurality of teeth, and wherein the plurality of teeth extend axially away from the first toothed ring and engage with a second plurality of teeth of the ratcheting mechanism.

9. The bicycle carrier of claim 7, wherein the first toothed ring is configured to translate within the hub.

10. The bicycle carrier of claim 7, wherein the first toothed ring is biased outwardly from the hub.

11. The bicycle carrier of claim 7, wherein the hub comprises a plurality of splines configured to prevent rotation of the first toothed ring.

12. The bicycle carrier of claim 7, wherein the hub comprises at least one protrusion extending away from the hub and configured to engage with at least one aperture formed through the first toothed ring to prevent rotation of the first toothed ring relative to the hub.

13. The bicycle carrier of claim 7, wherein the ratcheting mechanism further comprises a second toothed ring movably coupled to the wheel securement arm and configured to movably engage with the first toothed ring.

14. The bicycle carrier of claim 13, wherein the ratcheting mechanism further comprises an actuator coupled to the second toothed ring and configured to move the second toothed ring such that the ratcheting mechanism moves from an engaged position to a disengaged position.

15. The bicycle carrier of claim 7, wherein the ratcheting mechanism further comprises a second toothed ring fixedly coupled to the wheel securement arm and configured to engage with the first toothed ring.

16. The bicycle carrier of claim 2, wherein the actuator comprises an actuator button and a push member, wherein the actuator button is rotatably coupled to the wheel securement arm, and wherein the push member is configured to translate relative to the actuator button.

17. The bicycle carrier of claim 16, wherein the ratcheting mechanism further comprises a first toothed ring and a second toothed ring, and wherein when the actuator is rotated, the push member translates and moves the first toothed ring away from the second toothed ring to disengage the ratcheting mechanism.

18. The bicycle carrier of claim 16, wherein the push member comprises an actuating surface, a first notch formed in the actuating surface, and a second notch formed in the actuating surface, and
wherein the first notch has an engaged depth relative to the actuating surface and the second notch has a disengaged depth relative to the actuating surface less than the engaged depth.

19. The bicycle carrier of claim 18, wherein the actuator button comprises a protrusion configured to engage the first and second notches of the push member when the actuator button is rotated,
wherein when the protrusion engages the first notch, the ratcheting mechanism is in the engaged position, and
wherein when the protrusion engages the second notch, the ratcheting mechanism is in the disengaged position.

20. The bicycle carrier of claim 2, wherein the actuator automatically moves the ratcheting mechanism into the engaged position when the wheel securement arm moves into the second position from the first position.
